(19) United States
(12) Patent Application Publication
(10) Pub. No.: US 2011/0106509 A1
(43) Pub. Date: May 5, 2011

(54) IMPROVED TECHNIQUES FOR STOCHASTIC COMBINATORIAL OPTIMIZATION

(76) Inventors: Luc Mercier, San Francisco, CA (US); Pascal Van Hentenryck, Barrington, RI (US)

(21) Appl. No.: 12/736,003

(22) PCT Filed: Mar. 5, 2009
(86) PCT No.: PCT/US09/01449

§ 371 Date: Dec. 28, 2010

Related U.S. Application Data
(60) Provisional application No. 61/068,327, filed on Mar. 5, 2008.

(51) Int. Cl. G06F 17/10

(52) U.S. Cl. 703/2

(57) ABSTRACT

In one exemplary embodiment, a method includes: modeling, by at least one processor, a problem as an approximated exogenous Markov decision process (X-MDP); converting, by the at least one processor, the approximated X-MDP into a Markov decision process (MDP); solving, by the at least one processor, the MDP using at least one search algorithm to obtain a decision; and returning, by the at least one processor, the decision.

### TECHNICAL FIELD

The exemplary and non-limiting embodiments of this invention relate generally to stochastic algorithms, such as stochastic combinatorial optimization algorithms, and, more specifically, relate to improved techniques for solving combinatorial optimization problems (e.g., under uncertainty).

### BACKGROUND

One-step anticipatory algorithms make decisions online under uncertainty by ignoring non-anticipativity constraints in the future. They were shown to provide near-optimal decisions (in the expected sense) on a variety of online stochastic combinatorial problems in dynamic fleet management and resource allocation.

In recent years, progress in telecommunication and in information technologies has generated a wealth of online stochastic combinatorial optimization (OSCO) problems. These applications require decision-making under time constraints, given stochastic information about the future. Anticipatory algorithms have been proposed to address these applications (Van Hentenryck and Bent 2006). An algorithm is anticipatory if, at some point, it anticipates the future, meaning that it makes some use of the value of the clairvoyant. These anticipatory algorithms typically rely on two black-boxes: a conditional sampler to generate scenarios consistent with past observations and an offline solver for the deterministic version of the combinatorial optimization problem.

1s-AA is a simple one-step anticipatory algorithm. It works by transforming the multi-stage stochastic optimization problem into a 2-stage one by ignoring all non-anticipativity constraints but those of the current decision. This 2-stage problem is approximated by sampling, and the approximated problem is solved optimally by computing the offline optimal solutions for all pairs (scenario,decision).

### SUMMARY

In one exemplary embodiment of the invention, a method comprising: modeling, by at least one processor, a problem as an approximated exogenous Markov decision process (X-MDP); converting, by the at least one processor, the approximated X-MDP into a Markov decision process (MDP); solving, by the at least one processor, the MDP using at least one search algorithm to obtain a decision; and returning, by the at least one processor, the decision.

In another exemplary embodiment of the invention, an apparatus comprising: a memory configured to store input data descriptive of a problem; and at least one processor configured to receive the input data from the memory, to model the problem as an approximated exogenous Markov decision process (X-MDP), to convert the approximated X-MDP into a Markov decision process (MDP), to solve the MDP using at least one search algorithm to obtain a decision, and to return the decision.

In another exemplary embodiment of the invention, a program storage device readable by a machine, tangibly embodying a program of instructions executable by the machine for performing operations, said operations comprising: modeling a problem as an approximated exogenous Markov decision process (X-MDP); converting the approximated X-MDP into a Markov decision process (MDP); solving the MDP using at least one search algorithm to obtain a decision; and returning the decision.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows an exemplary instance of the stochastic project scheduling problem;

FIG. 2 depicts exemplary offline optimal schedules for the stochastic project scheduling instance of FIG. 1;

FIG. 3 illustrates exemplary experimental results for anytime decision making on the S-RCRSP;

FIG. 4 shows further exemplary experimental results for anytime decision making on the S-RCRSP;

FIG. 5 illustrates exemplary runtime behavior of Amsaa for the initial decisions on Reg.;

FIG. 6 shows an exemplary distribution of the depth of explored nodes by Amsaa for the initial decision;

FIG. 7 depicts convergence of the SAA expected value and upper bound;

FIG. 8(a) illustrates an exemplary project C on Reg.;

FIG. 8(b) depicts the exemplary project C in Reg. and in an exemplary simplified instance;

FIG. 9 shows an exemplary project D in Reg.;

FIG. 10 shows various equations that are referred to in the Detailed Description;

FIG. 11 depicts a flowchart illustrating one non-limiting example of a method for practicing the exemplary embodiments of this invention;

FIG. 12 illustrates an exemplary apparatus, such as a computer, with which the exemplary embodiments of the invention may be practiced; and

FIG. 13 depicts a representation of exemplary operations and/or components with which the exemplary embodiments of the invention may be practiced.

### DETAILED DESCRIPTION

Reference is herein made to the following publications:
[1] Barto, Andrew G., S. J. Bradtke, Satinder P. Singh. 1995. Learning to act using real-time dynamic programming. Artificial Intelligence 72(1) 81-138. Rtdp.
[2] Bent, R., P. Van Hentenryck. 2004. Scenario Based Planning for Partially Dynamic Vehicle Routing Problems with Stochastic Customers. Operations Research 52(6).
[3] Bent, R., P. Van Hentenryck. 2007. Waiting and Relocation Strategies in Online Stochastic Vehicle Routing. Proceedings of the 20th International Joint Conference on Artificial Intelligence, (IJCAI'07).
[4] Bonet, Blai, Hector Geffner. 2003. Faster heuristic search algorithms for planning with uncertainty and full feedback. Georg Gottlob, Toby Walsh, eds., IJCIA. Morgan Kaufmann, 1233-1238.
[5] Bonet, Blai, Hctor Geffner. 2006. Learning depth-first search: A unified approach to heuristic search in deterministic and non-deterministic settings, and its application to mdps. ICAPS.
[6] Choi, Jaein, Matthew J. Realff, Jay H. Lee. 2004. Dynamic programming in a heuristically confined state space: A stochastic resource-constrained project scheduling application. Computers and Chemical Engineering 28(6-7).
[7] Dempster, M. A. H. 1998. Sequential importance sampling algorithms for dynamic stochastic programming. Annals of Operations Research 84 153-184.
[8] Dooms, G., P. Van Hentenryck. 2007. Gap Reduction Techniques for Online Stochastic Project Scheduling. Tech. rep. (Submitted for Publication).
[9] Dupacova, J., N. Groewe-Kuska, W. Roemisch. 2003. Scenario Reduction in Stochastic Programming: An Approach using Probability Metrics. Mathematical Programming, Ser. A 95(4) 493-511.
[10] Dupacova, Jitka, Giorgio Consigli, Stein W. Wallace. 2000. Scenarios for multistage stochastic programs. Annals of Operations Research 100(1-4)25-53.
[11] Goel, Vikas, Ignacio E. Grossmann. 2006. A class of stochastic programs with decision dependent uncertainty. Math. Program 108(2-3) 355-394.
[12] Hansen, Eric A., Shlomo Zilberstein. 2001. LAO: A heuristic-search algorithm that finds solutions with loops. Artificial Intelligence 129(1-2)35-62.
[13] Kearns, M., Y. Mansour, A. Ng. 1999. A Sparse Sampling Alogorithm for Near-Optimal Planning in Large Markov Decision Processes. International Joint Conference on Artificial Intelligence (IJCAI'99).
[14] Mak, W. K., D. P. Morton, R. K. Wood. 1999. Monte carlo bounding techniques for determining solution quality in stochastic programs. Operations Research Letters 24 47-56.
[15] McMahan, H. Brendan, Maxim Likhachev, Geoffrey J. Gordon. 2005. Bounded real-time dynamic programming: RTDP with monotone upper bounds and performance guarantees. Luc De Raedt, Stefan Wrobel, eds., ICML. ACM, 569-576.
[16] Mercier, L., P. Van Hentenryck. 2007. Performance analysis of online anticipatory algorithms for large multistage stochastic integer programs. Manuela Veloso, ed., Proceedings of the 20th International Joint Conference on Artificial Intelligence (IJCAI 07), vol. 2.1979-1984.
[17] Parkes, D., A Duong. 2007. An Ironing-Based Approach to Adaptive Online Mechanism Design in Single-Valued Domains. Proceedings of the 22nd National Conference on Artificial Intelligence. 94-101.
[18] Ruszczynski, A., A. Shapiro, eds. 2003. Stochastic Programming, Handbooks in Operations Research and Management Series, vol. 10. Elsevier.
[19] Shapiro, A. 2006. On complexity of multistage stochastic programs. Oper. Res. Lett 34(1) 1-8.
[20] Thomas, M., H. Szczerbicka. 2007. Evaluating Online Scheduling Techniques in Uncertain Environments. Proceedings of the 3rd Multidisciplinary International Scheduling Conference. Paris, France.
[21] Van Hentenryck, P., R. Bent. 2006. Online Stochastic Combinatorial Optimization. The MIT Press, Cambridge, Mass.

### 1. INTRODUCTION

Herein applications are considered in which the aforementioned algorithms are not as close to the optimum and proposes Amsaa, an anytime multi-step anticipatory algorithm. Amsaa combines techniques from three different fields to make decisions online: the sampling average approximation method from stochastic programming, search algorithms for Markov decision processes from artificial intelligence, and discrete optimization algorithms. Amsaa was evaluated on a stochastic project scheduling application from the pharmaceutical industry featuring endogenous observations of the uncertainty. The experimental results show that Amsaa significantly outperforms state-of-the-art algorithms on this application under various time constraints.

1s-AA was shown to be very effective on a variety of OSCO problems in dynamic fleet management (Bent and Van Hentenryck 2004, 2007), reservation systems (Van Hentenryck and Bent 2006), resource allocation (Parkes and Duong 2007), and jobshop scheduling (Thomas and Szczerbicka 2007). Moreover, a quantity called the global anticipatory gap (GAG) was introduced by Mercier and Van Hentenryck (2007) to measure the stochasticity of the application and that paper showed that 1 s-AA returns high-quality solutions when the GAG is small.

Herein are considered OSCO applications with a significant GAG and it is proposed to address them with Amsaa, a multi-step anticipatory algorithm which provides an innovative integration of techniques from stochastic programming, artificial intelligence, and discrete optimization. Like 1s-AA, Amsaa samples the distribution to generate scenarios of the future. Contrary to 1s-AA however, Amsaa approximates and solves the multi-stage problem. The sample problem is solved optimally by a search algorithm (Bonet and Geffner 2003) using anticipatory relaxations to guide the search.

Amsaa was evaluated on a stochastic project scheduling problem proposed by Choi et al. (2004) to model the design and testing of molecules in a pharmaceutical company. This problem features a complicated combinatorial structure including precedence and cumulative resource constraints. In addition, the durations, costs, and results of the tasks are all uncertain, and the distributions for the tasks of a single project are not independent. Experimental results indicate that Amsaa outperforms a wide variety of existing algorithms on this application.

It is worth highlighting that the S-RCPSP features what are called endogenous observations: the uncertainty about a task can only be observed by executing it. This contrasts with OSCO problems studied earlier, in which the observations were exogenous, and leads to significant GAGs (Dooms and Van Hentenryck 2007). Amsaa thus applies to a large class of problems that are herein called Stoxuno problems (STochastic Optimization with eXogenous Uncertainty and eNdogenous Observations).

The remaining sections are organized as follows. Section 2 and 3 describe the motivating problem and delineate the scope of Amsaa's applicability. Section 4 presents a background in Markov Decision Processes and dynamic programming. Section 5 introduces the concept of Exogenous MDPs (X-MDPs) to model Stoxuno and exogenous problems. Section 6 describes Amsaa in detail. Section 7 discusses theoretical results. Experimental results are presented in Section 8, comparing Amsaa to various algorithms and studying its behavior in detail. Section 9 discusses some modelling issues not addressed earlier. Finally, Section 10 summarizes the contributions and discusses future directions.

### 2. THE STOCHASTIC RESOURCE-CONSTRAINED PROJECT SCHEDULING PROBLEM

The motivating problem is the stochastic resource-constrained project scheduling problem (SRCPSP or S-RCPSP), originating from the pharmaceutical industry (Choi et al. 2004) and presented as follows. A pharmaceutical company has a number of candidate molecules that can be commercialized if shown successful, and a number of laboratories to test them. Each molecule is associated with a project consisting of a sequence of tasks. Each task has a duration, a cost, and a result (e.g., a failure, which ends the project, or different degrees of success, which allow the project to continue). Tasks are not preemptive, and cannot be aborted once started. A project is successful if all its tasks are successful. A successful project generates a revenue which is a known non-increasing function of the completion date of the project. The goal is to schedule the tasks in the laboratories subject to the precedence and resource constraints to maximize the expected profit, the profit being the difference between the project revenues and their costs. The resource constraints impose that the number of tasks executing at any time t does not exceed the number of labs.

Each molecule's project has its own stochastic model. The realizations of a task are triplets of the form (duration, cost, result) and the durations, costs, and outcomes of the tasks in a given project are not independent. The more successful a task is, the higher the probability that the next task in the project will be successful too. Formally, the stochastic model for a project is a heterogeneous first-order Markov chain: for each task i, a transition matrix gives the probability of the realization of task i+1 given the realizations of task i. The task realizations, transition probabilities, and revenue functions are all given. Observe that it may be optimal to stop a project even if it has not failed so far. It is also possible that, at a given time, not scheduling any task in an available lab may be optimal. Indeed, waiting may reveal uncertain information and allow for more informed decisions, as already demonstrated in dynamic fleet management (Bent and Van Hentenryck 2007).

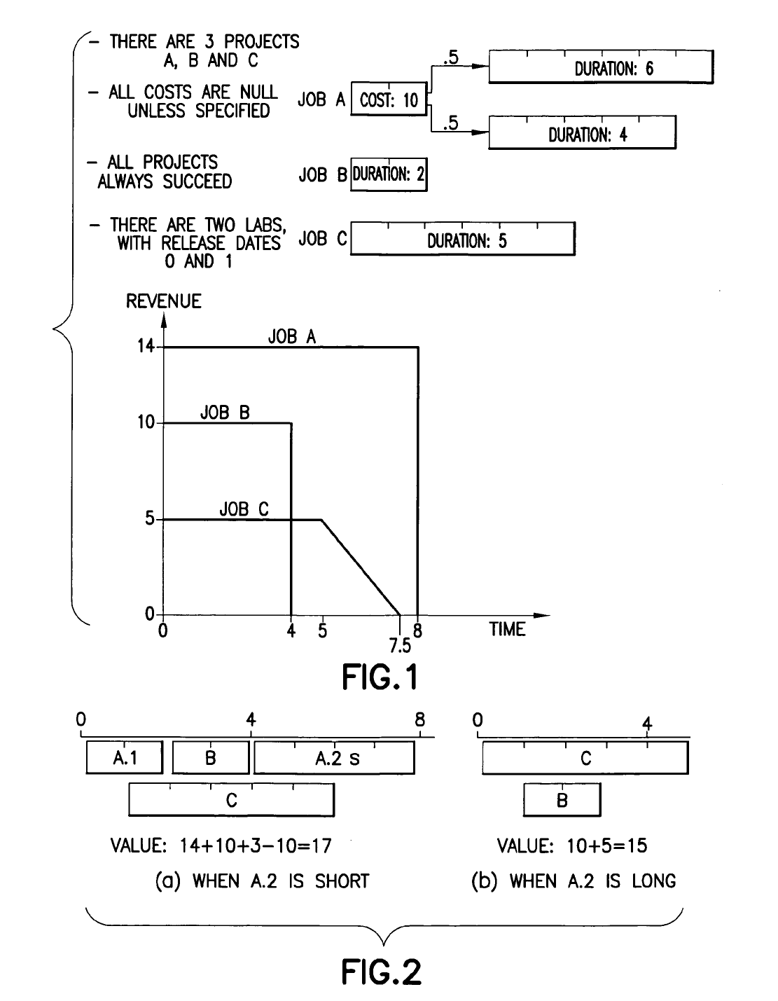

FIG. 1 shows an exemplary instance of the stochastic project scheduling problem. FIG. 2 depicts exemplary offline optimal schedules for the stochastic project scheduling instance of FIG. 1.

FIG. 1 depicts an exemplary small instance to illustrate these concepts. In the instance, there are 3 projects and 4 tasks, and all the projects always succeed. The two laboratories also have a release date, specifying when they become available. In this instance, the offline optimal schedules for the two possible realizations shown in FIG. 2 differ at the first decision when the uncertainty is not yet resolved. Hence the optimal online policy is necessarily inferior to a perfect clairvoyant decision maker. The schedule in FIG. 2(b) is the optimal online solution.

### 3. EXOGENEITY AND ENDOGENEITY

### Problem Classification

Traditionally, stochastic optimization problems were separated into two classes according to the exogenous or endogenous nature of their uncertainty. To delineate precisely the scope of Amsaa, one needs to refine this classification into purely exogenous, purely endogenous, and Stoxuno problems. Amsaa applies to both purely exogenous and Stoxuno problems.

Purely Exogenous Problems. These are problems in which the uncertainty, and the way it is observed, is independent of the decisions. For example, online stochastic combinatorial optimization problems in which the uncertainty comes from the behavior of customers or suppliers are purely exogenous. In this class, there is a natural concept of scenario (e.g., the sequence of customer requests) and, given two scenarios, it is possible to compute when they become distinguishable. As further non-limiting examples, nature is typically considered exogenous (e.g., water inflow in hydroelectric power scheduling), as well as prices in perfect markets, since an atomic agent cannot influence prices.

Purely Endogenous Problems. These are problems for which there is no natural concept of scenarios. Most benchmark problems for Markov Decision Processes are of this nature. For instance, problems of controlling robots typically have uncertainty derived from the imperfection of the actuators, and depends strongly on the signals they receive. It is not completely impossible to define scenarios on these problems, in the form of a collection of statements such as “if at time t signal x is sent to actuator a, the response will be r”, but such scenarios have no clear meaning or value.

Stoxuno Problems (STochastic Optimization problems with eXogenous Uncertainty and eNdogenous Observations). These are problems like the S-RCPSP, for which the underlying uncertainty is exogenous, but observations depend on the decisions. In these problems, the concept of scenario is well-defined and meaningful. However, given two scenarios, it is not possible to decide when a decision maker will be able to distinguish them. Many scheduling problems with uncertainty on tasks belong to this category, as does the lot sizing problem in (Goel and Grossmann 2006), for example.

### 4. BACKGROUND IN STOCHASTIC DYNAMIC PROGRAMMING

Stochastic Dynamic Programming aims to solve stochastic optimization problems modeled as Markov Decision Processes (MDP). MDPs are the model of choice for purely endogenous problems, but they can be and have been used also on Stoxuno and purely exogenous problems. There are several variants of MDPs. For the purposes herein, and as non-limiting examples, attention will be restricted to processes with rewards on final states only (no transition cost), no discounting, and finite state spaces.

### 4.1. Markov Decision Processes

A Markov Decision Process (S, s₀, F, X, ⊥, χ, f, P) consists of:
a finite state space S, an initial state s₀εS, and a set of final states F⊂S .
a decision space X containing a decision ⊥ (denoting no action) and a function χ:S→X returning the set of feasible decisions in a given state such that ∀sεS, 0<# χ(S)<∞ and that ∀sεF, χ(s)={⊥}.
a bounded reward function ƒ:F→R.
a transition function P:S×X→prob(S), where prob(S) is the set of probability distributions over S, satisfying ∀sεF, P(s, ⊥)({s})=1.

For convenience, write P(•|s, x) instead of P(s,x)(•). A run of an MDP (S, s₀, F, X, ⊥, χ, f, P) starts in initial state s₀. At a given state s, the decision maker selects a decision xεχ(S) which initiates a transition to state s₀ with probability P(s′|s, x) (in case of finite state space. More generally, the transition goes to a state s′εA⊂S with probability P(A|s, x) for any measurable set A. The resulting sequence of states and decisions, i.e.

$${s}_{0} {\to }^{ {x}_{0} } {s}_{1} {\to }^{ {x}_{1} } … {\to }^{ {x}_{t} - 1 } {s}_{t} {\to }^{ {x}_{t + 1} } … ,$$

is called a trajectory. This random process is said to be Markovian because, conditionally on sᵢ and xᵢ, the probability distribution of sᵢ₊₁ is independent of the past trajectory.

Also assume that the horizon is finite. That is, there exists an integer T such that all trajectories starting in s₀ are such that s_{T} is final. A corollary of that assumption is that the state space graph has to be acyclic. (Most of this discussion would still be valid with the weaker assumption that a final state is reached almost surely in finite time regardless of the decisions made). Under these assumptions, the objective of the decision maker is to maximize E[f(s_{T})].

### 4.2. Policies, Value Functions, and Optimality

A (deterministic) Markovian policy π:S→X is a mapping from states to feasible decisions (i.e., ∀sεS, π(s)εχ(s)). The value ν_{π}(s) of policy π in state s is the expected value obtained by running policy π from state s. A policy π is optimal if ν₉₀ (s₀) is maximal among all policies.

A value function ν is a map S→R. The Q-value function canonically associated with ν is the mapping S×X→R defined by Q(s,x)=Σ_{sεS}P(s′|s, x)ν(s′). Given a value function ν and a state s, a decision xεχ(s) is greedy if Q(s,x)=max_{x′εχ(s)} Q(s,x). Further assume that there is a rule to break ties, so one can consider “the” greedy decision even though it may not be unique. The greedy policy π_{ν} associated with a value function ν is the policy defined by taking the greedy decision in every state. A value function is optimal if the associated greedy policy is optimal. A necessary and sufficient condition for ν to be optimal is that, for all states s reachable under π_{ν}, one has ν(s)=f(s) if s is final, and Re s_{ν}(s)=0 otherwise, where R es_{ν}(s)=ν(s)−max Q(s,x) is called the Bellman residual of ν at s. Under these assumptions, there is always an optimal value function v*.

### 5. EXOGENOUS MARKOV DECISION MODELS

Section 3 discussed exogeneity and endogeneity of the uncertainty as being part of the nature of the problem. This is to be distinguished from endogeneity or exogeneity of the representation of the uncertainty in the model. Markov decision processes model uncertainty in an endogenous way: the uncertainty depends on the actions of the decision maker. MDPs can certainly accommodate non-endogenous problems, but it is argued that, when the uncertainty is exogenous, it is better to use a model that represents the uncertainty exogenously. Such models already exist: stochastic programs, except for some rare variations, model the uncertainty exogenously but they cannot capture Stoxuno problems. As a result, exogenous Markov decision processes (XMDPs) are introduced for modeling purely exogenous and Stoxuno problems. Note that X-MDPs are neither more nor less expressive than traditional MDPs, but they suggest the design of algorithms that take advantage of the exogeneity of the uncertainty.

### 5.1. Exogenous Markov Decision Processes

An X-MDP (S, s₀, F, X, ⊥, χ, f, ξ, μ_{ξ}, τ) consists of:
a state space S, an initial state sεS, and a set of final states F⊂S .
a decision space X containing a decision ⊥ (denoting no action) and a function χ:S→X returning the set of feasible decisions in a given state such that ∀sεS, 0<# χ(s)<∞ and that ∀sεF, χ(s)={⊥}.
a bounded reward function ƒ:F→R.
a random variable ξ taking values from a scenario space Ξ whose distribution is μ_{ξ}.
a (deterministic) transition function τ:S×X×Ξ→S satisfying ∀sεS, ∀ξεΞ, τ(s, ⊥, ξ)=s.

Running an X-MDP includes first sampling a realization ξ of the random variable ξ: The realization ξ is not known to the decision maker and is only revealed progressively through observed outcomes of the transitions. Starting in state s₀, the decision maker takes a decision, observes the outcome of the transition, and repeats the process. For a state s and a decision x, the next state becomes τ(s, x, ξ). The alternation of decisions and state updates defines a trajectory

$${s}_{0} {{\to }_{ξ}}^{ {x}_{0} } {s}_{1} {{\to }_{ξ}}^{ {x}_{1} } … {{\to }_{ξ}}^{ {x}_{t - 1} } {s}_{t}$$

satisfying (1) xᵢεχ(sᵢ) and (2) sᵢ₊₁=τ(sᵢ, xᵢ, ξ) for all i. A trajectory corresponding to an unspecified scenario is denoted by

$${s}_{0} {\to }^{ {x}_{0} } {s}_{1} {\to }^{ {x}_{1} } … {\to }^{ {x}_{t - 1} } {s}_{t}$$

A scenario ξ is compatible with a trajectory

$${s}_{0} {\to }^{ {x}_{0} } {s}_{1} {\to }^{ {x}_{1} } … {\to }^{ {x}_{t - 1} } {s}_{t}$$

if τ(sᵢ, xᵢ, ξ)=sᵢ₊₁ for all i<t. The set of scenarios compatible with the trajectory

$${s}_{0} {\to }^{ {x}_{0} } … {\to }^{ {x}_{t - 1} } {s}_{t}$$

is denoted by

$$C ( {s}_{0} {\to }^{ {x}_{0} } … {\to }^{ {x}_{t - 1} } {s}_{t} ) .$$

A scenario is compatible with a state s if it is compatible with a trajectory from s₀ to s. C(s) denotes the set of scenarios compatible with state s.

Similar assumptions are made for X-MDPs as compared with MDPs. In particular, also assume a finite horizon, that is the existence of a stage T such that s_{T} is final regardless of the decisions and the scenario realization. The objective also consists of maximizing E[f(s_{T})], which is always defined if f is bounded. Finally, also impose a Markovian property for X-MDPs, which ensures the dominance of Markovian policies. In the context of X-MDPs, this property becomes:
for all trajectories

$${s}_{0} {\to }^{ {x}_{0} } … {\to }^{ {x}_{t - 1} } {s}_{t} , \\ \\ C ( {s}_{0} {\to }^{ {x}_{0} } … {\to }^{ {x}_{t - 1} } {s}_{t} ) = C ( {s}_{t} ) .$$

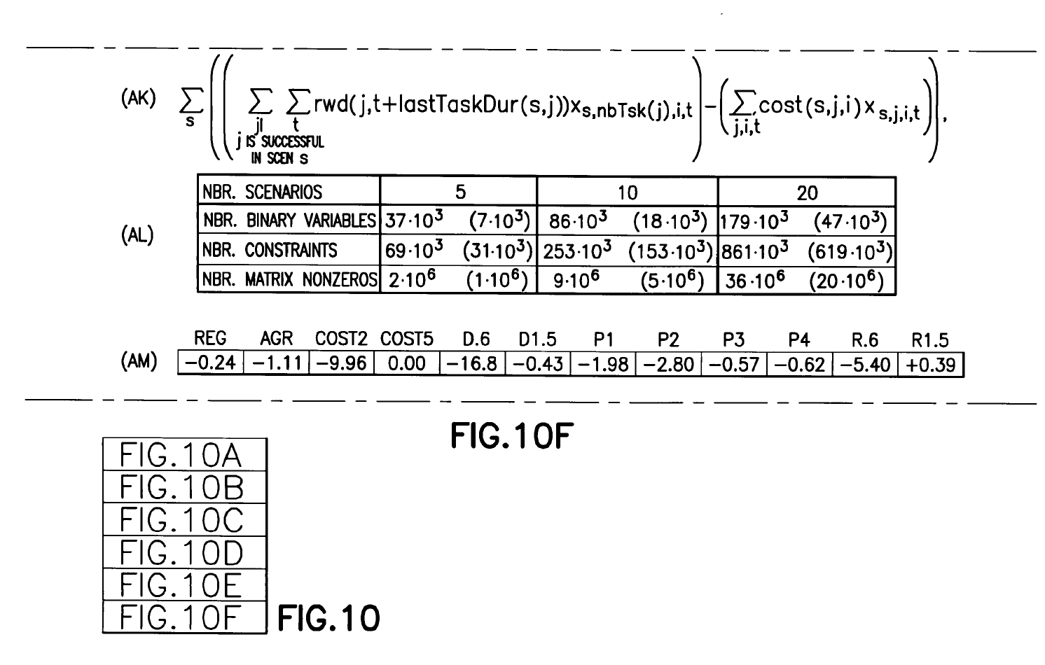

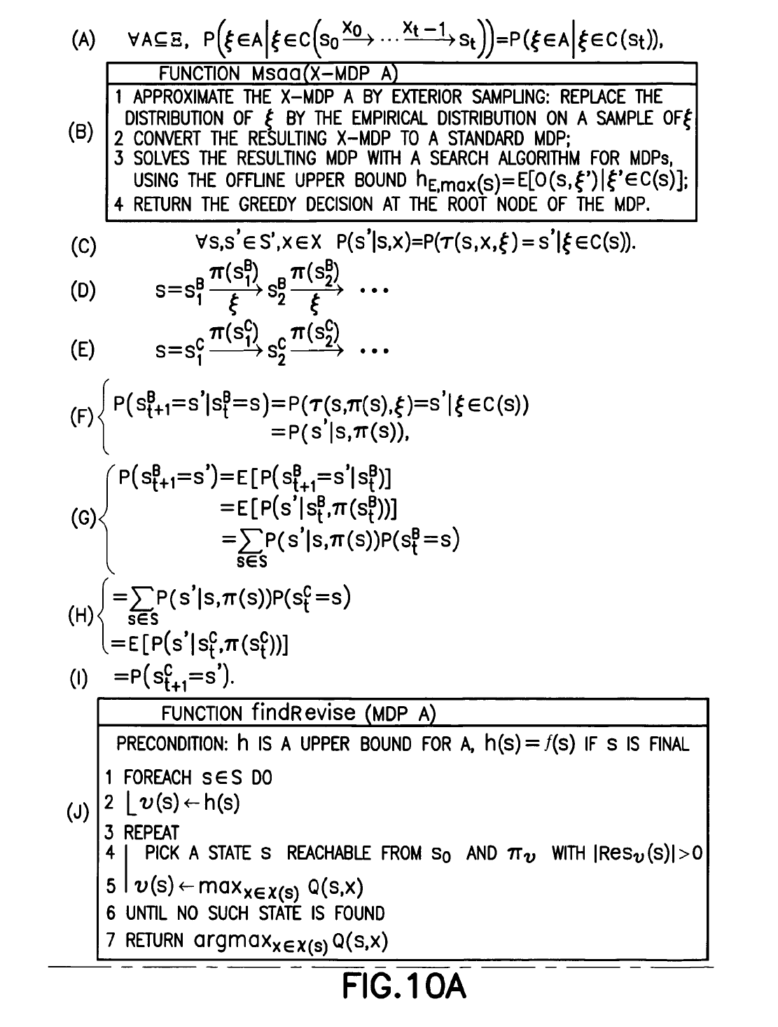

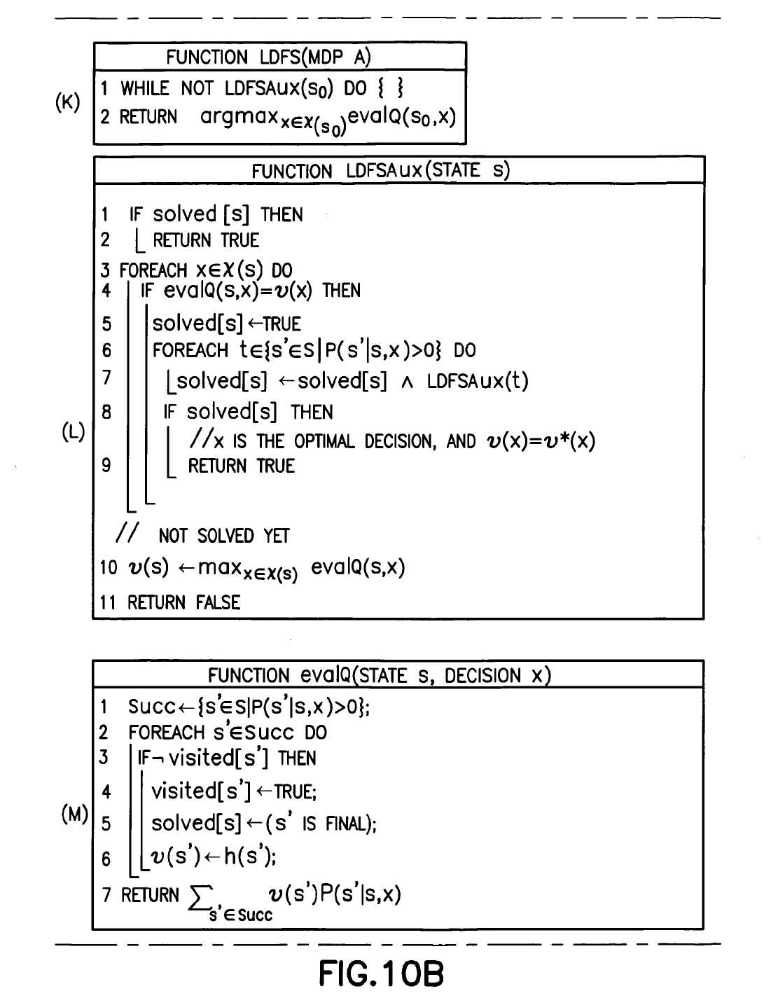

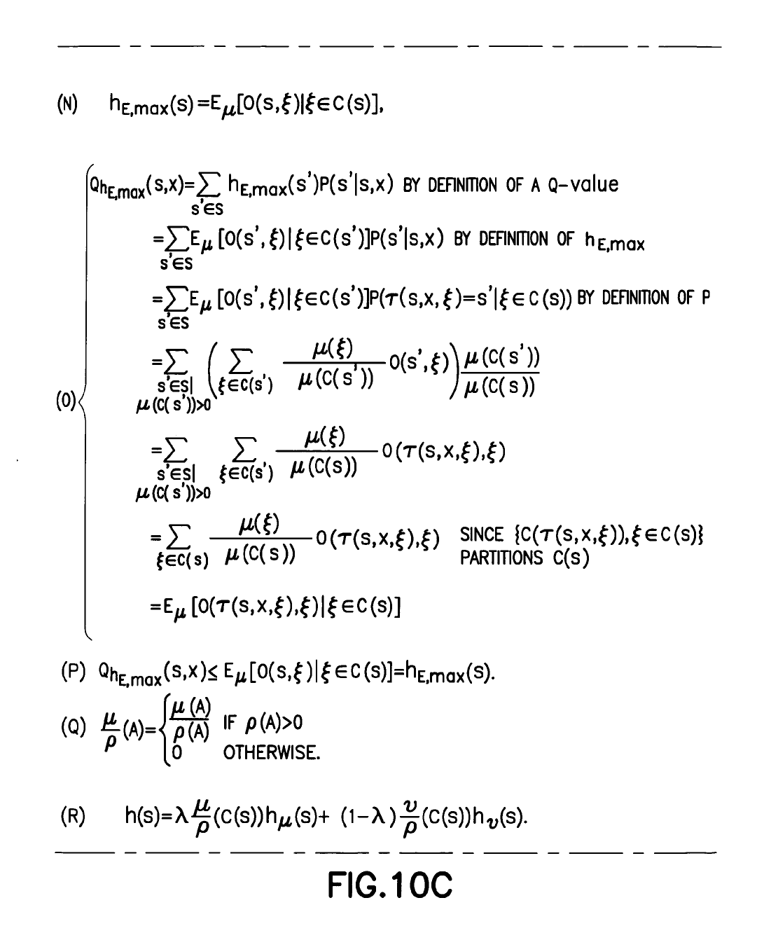

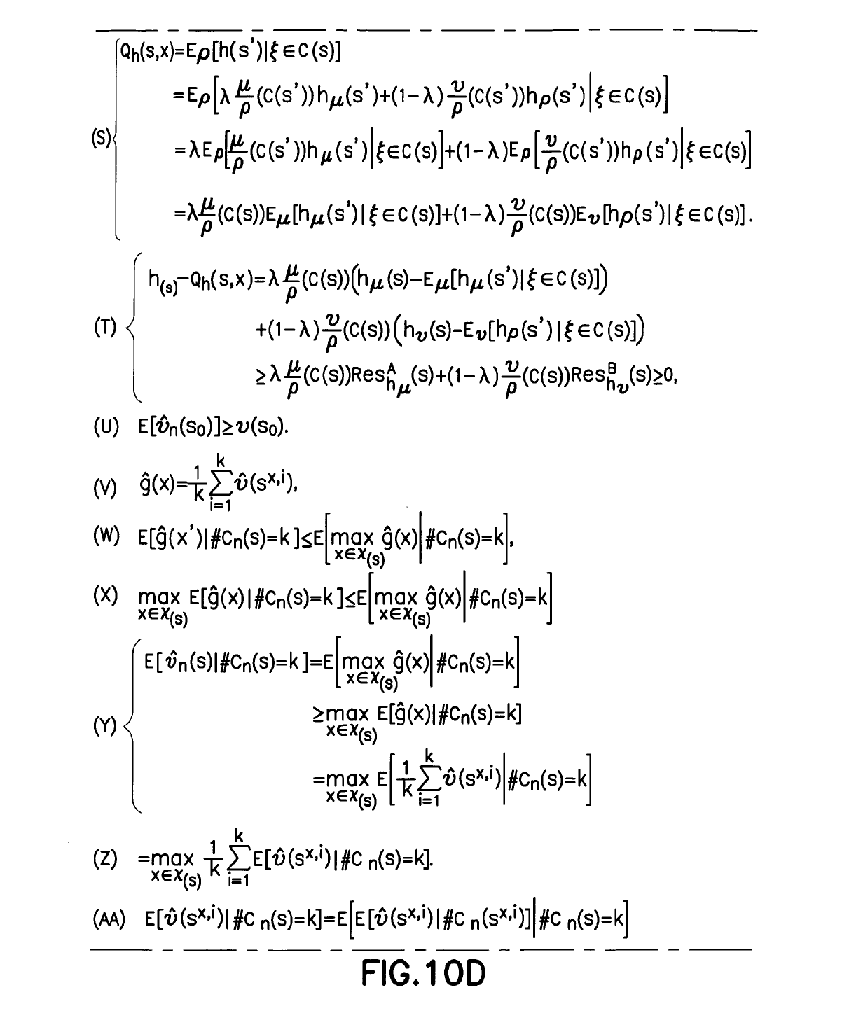

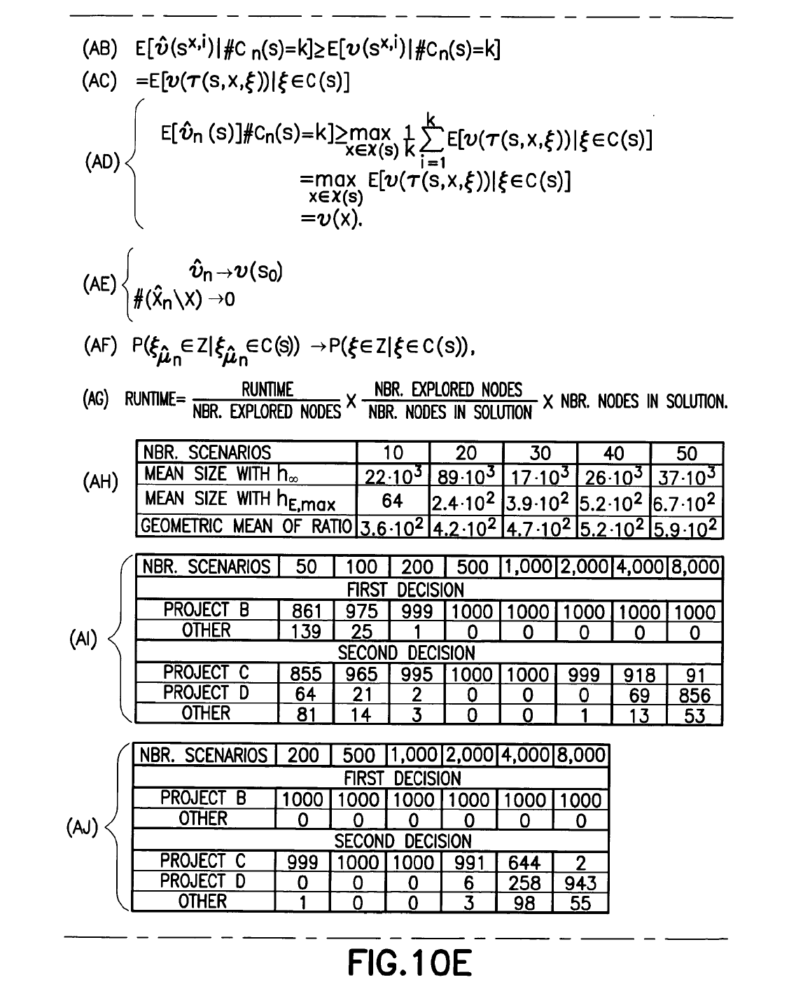

It is easy to enforce this property in practice: simply include all past observations into the current state. An elementary but important corollary of this assumption is that conditional probabilities on the past trajectory are identical to conditional probabilities on the current state, i.e., as shown in FIG. 10(A).

Hence, sampling scenarios conditionally on the current state is equivalent to sampling scenarios conditionally on the past trajectory.

5.2. Offline Deterministic Problems Associated with X-MDPs

X-MDPs enjoy a fundamental property: they naturally exhibit an underlying deterministic and offline problem that has no counterpart in MDPs.

DEFINITION 1. The offline value of state s under scenario ξ, denoted by O(s,ξ), is the largest reward of a final state reachable from state s when ξ=ξ. It is defined recursively by:

$$O ( s , ξ ) = \{ \begin{matrix}f ( s ) & if s is final ; \\ {max}_{x ∈ χ ( s )} O ( τ ( s , x , ξ ) , ξ ) & otherwise .\end{matrix}$$

Consider the instance presented in Section 2. If ξₛ and ξ₁ denote the scenarios in which A.2 is short and long respectively, then O(s₀, ξₛ)=17 and O(s₀, ξ₁)=15, as shown in FIG. 2.

### 5.3. Value Functions and Optimality for X-MDPs

Like for MDPs, it is possible to define the value of a policy for an X-MDP. Let A be an X-MDP and π:S→X be a policy for A. Consider a past trajectory

$${s}_{0} {\to }^{ {x}_{0} } … {\to }^{ {x}_{t - 1} } {s}_{t}$$

, not necessarily generated by π. Recall that for any trajectory s_{T} is final. Therefore the expected value obtained by following π after this past trajectory is well defined and is denoted by

$${v}_{π} ( {s}_{0} {\to }^{ {x}_{0} } … {\to }^{ {x}_{t - 1} } {s}_{t} ) .$$

Now remember the relation as shown in FIG. 10(A). Therefore the (random) future trajectory following π only depends on sₜ and not on earlier states and decisions. As a consequence, one can define

$${v}_{π} ( {s}_{t} ) = {v}_{π} ( {s}_{0} {\to }^{{x}_{0}} … {\to }^{{x}_{t - 1}} {s}_{t} ) .$$

A policy π* is optimal if ν_{π*}(s₀) maximizes ν_{π}(s₀) over all policies π. For simplicity, in various sections of this paper, ν_{π*}(s) is denoted by ν(s) (and/or by v(s)).

### 5.4. Benefits of X-MDPs Over MDPs

Although X-MDPs can be turned into equivalent MDPs, they have two computational advantages: the existence of offline, deterministic problems and the ability to use exterior sampling.

Offline Problems. The existence of offline problems is one of the reasons for the success of anticipatory algorithms for online stochastic combinatorial optimization (Mercier and Van Hentenryck 2007, Van Hentenryck and Bent 2006). Contrary to MDPs, X-MDPs naturally reveal underlying offline problems, which can then be exploited by algorithms such as Amsaa. Indeed, computing O(s, ξ) is a deterministic combinatorial problem for which a variety of advanced optimization techniques may be applicable. Section 6.4.3 shows how these offline values guide the search in finding optimal policies and the experimental results will demonstrate their fundamental role in achieving good performance. In this discussion, as was already the case for (Van Hentenryck and Bent 2006), assume that one has at his/her disposal a black-box to solve these offline problems or to compute good upper bounds of O(s, ξ) quickly.

Exterior Sampling. In MDPs, one can only sample outcomes of state-decision pairs. In contrast, in X-MDPs a set of scenarios can be sampled a priori and independently of the decisions. Section 6.2.2 will explain why this ability makes it possible to reduce the number of scenarios needed to find high-quality policies.

### 5.5. Modeling the Stochastic RCPSP as an X-MDP

Consider now a sketch of the modeling of the S-RCPSP as an X-MDP. Because tasks cannot be preempted or aborted, the X-MDP states correspond to times when at least one laboratory is available. More precisely, a state contains:
the current time;
the set of currently running tasks with their start times (but without lab assignment);
the set of all past observed task realizations.

The Markov property for X-MDPs is satisfied since all past observations are stored. There are two types of decisions: (1) scheduling a given task on one of the available laboratories or (2) waiting. In both cases, the successor τ(s, x, ξ) corresponds to the next time a decision must be taken. This can be the current time when several laboratories are available for schedule, since tasks are scheduled one at a time in this model. In all other cases, the next state corresponds to a later time. The model contains a symmetry-breaking constraint, using an ordering on the projects. If a task of project k is scheduled at time tin state s, none of the tasks in projects 1 . . . k−1 can be scheduled in a descendent s′ of s if state s′ is associated with time t too.

### 6. AMSAA

### An Algorithm for Decision Making in X-MDPs

This section presents a contribution: Amsaa, the Anytime Multi-Step Anticipatory Algorithm for combinatorial optimization problems with exogenous uncertainty. First a high-level overview of Amsaa is discussed before presenting each step in detail.

### 6.1. Overview of Amsaa

The core of Amsaa is the Multi-Step Anticipatory Algorithm (Msaa) summarized as shown in FIG. 10(B). Note that this is a non-limiting example.

The first step of Msaa approximates the X-MDP by exterior sampling to make it more tractable. It then converts the resulting X-MDP into an MDP, making it possible to apply standard search algorithms for MDPs. The third step applies such an algorithm using an upper bound that exploits the value of the offline problems associated with the approximated X-MDPs. Finally, the fourth step returns the decision selected by the optimal policy at the root node of the MDP. Note that Msaa exploits the exogenous nature of the uncertainty in steps 1 and 3, i.e., to approximate the problem and to guide the search towards the optimal policy.

Amsaa is an anytime algorithm based on Msaa. It iteratively applies algorithm Msaa on increasingly finer approximations of the original X-MDP until some termination condition is met. Operationally, such a condition is likely to be a time constraint (e.g., “make a decision within one minute”) but it could also be a stopping criterion based on some accuracy measure such as the contamination method (Dupacova et al. 2000). This iterative refinement is made efficient by the incremental nature of Amsaa: calls to Msaa reuse earlier computations, so that resolving the MDP is fast after a small change in the approximation. Below, each component of Amsaa is considered.

### 6.2. Approximating the X-MDP

The first step of Amsaa is to approximate the original X-MDP by replacing the distribution of the scenarios by one with a finite and reasonably small support.

6.2.1. The Sample Average Approximation Method A simple way of approximating a distribution is by sampling. For stochastic programs, this idea is called the Sample Average Approximation (SAA) method (Ruszczynski and Shapiro 2003) and it extends naturally to XMDPs. Suppose one wants a distribution whose support has cardinality at most n: sample ξ n times, independently or not, to obtain ξ¹, . . . , ξⁿ and define \hat{μ}ₙ as the empirical distribution of ξ′ induced by this sample, i.e., the distribution assigning probability 1/n to each of the sampled scenarios. In the following, use A and Âₙ to denote the X-MDPs A_{μ} and A_{\hat{μ}}_{ₙ}.

6.2.2. The Benefits of Exterior Sampling for X-MDPs Sampling can be used either to approximate a problem that is then solved exactly (The SAA method) or to compute an approximate solution of the original problem. Amsaa approximates the original problem and solves the resulting X-MDP exactly (exterior sampling). Kearns et al. (1999) (KMN) took the other road: they proposed an algorithm to solve approximately an MDP by sampling a number of outcomes at each visited state (interior sampling). Their algorithm was presented for discounted rewards but generalizes to the objective and assumptions of this paper. However, interior sampling does not exploit a fundamental advantage of problems with exogenous uncertainty: positive correlations.

Indeed, in a state s, the optimal decision maximizes Q*(s,x), where Q* is the Q-value function associated to the optimal value function v*. However, estimating this value precisely is not important. What really matters is to estimate the sign of the difference Q*(s,x₁)−Q*(s,x₂) for each pair of decisions x₁,x₂εχ(s). Now, consider two functions g and h mapping scenarios to reals. Two examples of such functions are:
1. the offline values for two decisions: g(ξ)=O(τ(s,x₁,ξ),ξ) and h(ξ)=O(τ(s,x₂,ξ),ξ);
2. the optimal policy value obtained from a state s after making a first decision. That is, g(ξ)=ν(τ(s₀,x₁,ξ)) and h(ξ)=ν(τ(s₀,x₂,ξ)) for two decisions x₁,x₂εχ(s₀).

If ξ¹ and ξ² are iid scenarios, then

var(g(ξ¹)−h(ξ²))=var(g(ξ¹))+var(h(ξ²)),

var(g(ξ¹)−h(ξ¹))=var(g(ξ¹))+var(h(ξ¹))−2cov(g(ξ¹),h(ξ¹)),

and therefore

var(g(ξ¹)−h(ξ¹))=(1−acorr(g(ξ¹),h(ξ¹)))·var(g(ξ¹)−h(ξ¹))

where acorr

$$( X , Y ) = \frac{cov ( X ) cov ( Y )}{1 / 2 ( var ( X ) + var ( Y ) )}$$

is a quantity called arithmetic correlation.

Note that acorr(X,Y) is close to corr(X,Y) when var(X) and var(Y) are close. Now consider an infinite iid sample ξ¹, ξ^{1′}, ξ², ξ^{2′}, . . . , and a large integer n. By the central limit theorem, the distributions of

$$\frac{1}{n} {\sum }_{i = 1}^{n} g ( {ξ}^{i} ) - h ( {ξ}^{i} ) and or \frac{1}{n γ} {\sum }_{i = 1}^{n γ} g ( {ξ}^{i} ) - h ( {ξ}^{{i}^{′}} )$$

are almost the same when 1/γ=1−acorr (g(ξ¹),h(ξ¹)). Therefore, for some specified accuracy, the number of required scenarios to estimate the expected difference between g(ξ) and h(ξ) is reduced by this factor γ when the same scenarios (exterior sampling) are used instead of independent scenarios (interior sampling). This argument is not new and can be found in, say, (Ruszczynski and Shapiro 2003, Ch. 6). However, no empirical evidence of high correlations were given, which are now reported. Consider an SAA problem approximating the standard instance of the S-RCPSP application with 200 scenarios generated by iid sampling, and consider the offline and optimal policy values in the initial state for the 6 possible initial decisions. Associating a column with each decision, the values for the first 8 scenarios are:

$$OfflineValue = 1 e 4 \times ( \begin{matrix}0 & 2.170 & 2.170 & 2.125 & 2.130 & 2.170 \\ 0 & - 0.050 & - 0.030 & - 0.065 & - 0.060 & - 0.060 \\ 0 & - 0.030 & - 0.025 & - 0.060 & - 0.055 & - 0.060 \\ 0 & 1.440 & 1.470 & 1.405 & 1.470 & 1.410 \\ 0 & 1.160 & 1.160 & 1.135 & 1.130 & 1.185 \\ 0 & - 0.025 & - 0.050 & - 0.065 & - 0.055 & - 0.060 \\ 0 & 0.829 & 0.804 & 0.829 & 0.789 & 0.769 \\ 0 & 2.015 & 2.015 & 2.005 & 2.065 & 2.065\end{matrix} )$$

$$OptPolicyValue = 1 e 4 \times ( \begin{matrix}0 & 2.110 & 2.038 & 1.910 & 1.893 & 2.170 \\ 0 & - 0.265 & - 0.275 & - 0.275 & - 0.275 & - 0.225 \\ 0 & - 0.205 & - 0.230 & - 0.230 & - 0.170 & - 0.170 \\ 0 & 1.375 & 1.405 & 1.279 & 1.345 & 1.365 \\ 0 & 1.045 & 1.070 & 1.015 & 1.105 & 1.160 \\ 0 & - 0.140 & - 0.195 & - 0.255 & - 0.275 & - 0.180 \\ 0 & 0.829 & 0.804 & 0.789 & 0.230 & 0.255 \\ 0 & 1.811 & 1.955 & 1.955 & 2.015 & 2.015\end{matrix} )$$

The first columns correspond to the decision of not scheduling anything, which is why it is always zero. Other columns correspond to scheduling the first task of each project respectively. The correlation is evident. The arithmetic correlation matrices, computed over the 200 scenarios, are:

$$OfflineArithCorr = ( \begin{matrix}NaN & 0 & 0 & 0 & 0 & 0 \\ 0 & 1 & .9977 & .9958 & .9975 & .9966 \\ 0 & .9977 & 1 & .9963 & .9968 & .9973 \\ 0 & .9958 & .9963 & 1 & .9968 & .9974 \\ 0 & .9975 & .9968 & .9968 & 1 & .9972 \\ 0 & .9966 & .9973 & .9974 & .9972 & 1\end{matrix} )$$

$$OptPolicyArithCorr = ( \begin{matrix}NaN & 0 & 0 & 0 & 0 & 0 \\ 0 & 1 & .9874 & .9886 & .9583 & .9404 \\ 0 & .9874 & 1 & .9934 & .9662 & .9486 \\ 0 & .9886 & .9934 & 1 & .9645 & .9429 \\ 0 & .9583 & .9662 & .9645 & 1 & .9886 \\ 0 & .9404 & .9486 & .9429 & .9886 & 1\end{matrix} )$$

These correlations are very high, the smallest being 99% for the offline values and 94% for the optimal policy values. Moreover, the minimal correlation for the optimal policy values becomes 98.7% when only decisions 2-4, which have the highest Q-value, are considered.

It remains to see whether these correlations are a characteristic of the problem or even of the instance. It is conjectured that, instead, this will be the case in the overwhelming majority of XMDPs originating from OSCO applications. Indeed, in most problems, some scenarios are more favorable than others regardless of the decisions. For example, in the S-RCPSP, scenarios with many successful projects bring more money than scenarios with many failures, exhibiting a positive correlation between the values of the actions. Finding realistic OSCO problems in which decisions are not positively correlated is hard. For example, in a portfolio management problem, one might expect the decision of selling some stock to be negatively correlated to the decision of buying more of the same stock. But this is not true: if trading fees are small and if the optimal policy is to buy more, then the optimal policy following the decision to sell the stock will be to rebuy them. They will be a loss due to fees and to the price difference between the sale and the rebuy, but there will be a positive correlation of values for the two decisions. As a result, it is conjectured that, for most OSCO problems, exterior sampling will converge with far fewer scenarios than interior sampling.

### 6.3. Converting the X-MDP to an MDP

The second step of Amsaa consists of converting the approximated X-MDP into an MDP. It proceeds in two stages: First trimming the X-MDP to remove unreachable states, before performing the actual conversion.

6.3.1. Trimming X-MDPs Trimming consists in eliminating unreachable states and in marking as final those states in which all the uncertainty has been revealed.

DEFINITION 2. Given an X-MDP A with state-space S and final states set F, the trimmed X-MDP B induced by A is the X-MDP that is in all equal to A, except:
1. its state space is S′={sεS|C(S)≠Ø};
2. its set of final states set is F′=F∪{sεS′|#C(s)=1};
3. its feasible decision function χ′(s) which is χ(s) if sεF′\F and {⊥} otherwise;
4. its reward function ƒ′ is defined over the states in F′\F and has value f(s)=O(s,ξ) where ξ is the unique scenario compatible with s.

LEMMA 1. Let A be an X-MDP and B be its trimmed version. Then:
1. For any policy π in A optimal for states in S′\F , one has for all sεS′, ν_{π}^{A}(s)=ν_{π}^{B}(s);
2. For any policy π in B, the policy \tilde{π} in A defined by \tilde{π}(s)=π(s) for sεS′\(F′\F) and by \tilde{π}(s)=arg max_{xεχ(s)} O(τ(s,x),ξ) for states in F′\F , with ξ the unique scenario compatible with s, satisfies ∀sεS′, ν_{\tilde{π}}^{A}(s)=ν_{π}^{B}(s).

6.3.2. Converting Trimmed X-MDPs It remains to show how to transform a trimmed X-MDP into an MDP.

DEFINITION 3. Let B=(S′, s₀, F′, X, ⊥, χ′, f, ξ, μ_{ξ}, τ) be the trimmed version of X-MDP A. Define P from S×X to the set of probability distributions on X by the equation of FIG. 10(C).

Then C=(S′, s₀, F′, X, ⊥, χ′, f, P) is the MDP induced by X-MDP A.

LEMMA 2. For any policy π, one has ∀sεS, ν^{B}(s)=ν^{C}(s).

This lemma is a consequence of the Markov property for X-MDPs, which implies that, following π in B or C, for all t the distribution of sₜ is the same in B and in C.

Proof (Assume S′ finite here, which may be the only case in which one uses this theorem.) Consider the random trajectory defined by running π in B starting in s, on the random scenario ξ′, denoted as in FIG. 10(D), and the one defined by running π in C starting in s, denoted as in FIG. 10(E).

By induction, it is proven that the distributions of sₜ^{B} and sₜ^{C} are the same. This is true for t=1. Now, suppose it is true at t. Considers and s′ in S′. One has as shown in FIG. 10(F) with this last equality following the definition of P. Now one has as shown in FIG. 10(G), and, by induction hypothesis, one obtains as in FIG. 10(H), which, by definition of an MDP, is as shown in FIG. 10(I).

Hence sₜ₊₁^{B} and sₜ₊₁^{C} are equally distributed. By recursion, for t=T one has E[f(s_{T}^{B})]=E[f(s_{T}^{C})]. Now, these two quantities are precisely ν_{π}^{B}(s) and ν_{π}^{C}(s), so they are equal.

See FIGS. 10(J) and 10(K) regarding functions findRevise(MDP A) and LDFS(MDP A), respectively.

THEOREM 1. Let A be an X-MDP, B its trimmed version, and C the MDP induced by B.
1. For any policy π in A optimal for states in F′\F, one has for all ∀sεS. ν_{π}^{A}(s)=ν_{π}^{C}(s);
2. For any policy π in C, the policy \tilde{π} in A defined by \tilde{π}(s)=π(s) for sεS′\(F′\F) and by \tilde{π}(s). arg max_{xεχ(s)} O(τ(s,x),ξ) for states in F′\F, with ξ the unique scenario compatible with s, one has that ∀sεS′, ν_{\tilde{π}}^{A}(s)=ν_{π}^{C}(s).

Proof Direct consequence of lemmas 1 and 2.

### 6.4. Solving MDPs

Once the X-MDP is converted into an MDP, it is possible to apply existing algorithms for solving the MDP optimally. In this section, such an exemplary algorithm is described from a class called heuristic search algorithms, which, despite their names, are exact algorithms. The presentation here follows (Bonet and Geffner 2006) which contains a synthesis of these algorithms.

6.4.1. Heuristic Search Algorithms for MDPs Heuristic search algorithms for MDPs perform a partial exploration of the state space, using a—possibly monotone—upper bound to guide the search. A value function h:S→R is an upper bound if ∀sεS, h(s)≧ν*(s). A value function is a monotone upper bound if it is an upper bound and if R esₕ(s)≧0 for all states s. Intuitively, a monotone upper bound is an optimistic evaluation of a state that cannot become more optimistic if a Bellman update is performed.

Function findAndRevise, introduced by (Bonet and Geffner 2003), captures the general schema of heuristic search algorithm for MDPs and returns an optimal value function upon termination. At each step, the algorithm selects a state reachable with the current policy π_{ν} whose Bellman residual is non-zero and performs a Bellman update. When h is monotone, only strictly positive (instead of non-zero) Bellman residuals must be considered, and the value function v remains a monotone upper bound during the entire execution of the algorithm. Different instantiations of this generic schema differ in the choice of the state to reconsider. They include, among others, HDP (Bonet and Geffner 2003), Learning Depth-First Search (LDFS) (Bonet and Geffner 2006), Real-Time Dynamic Programming (RTDP) (Barto et al. 1995), Bounded RTDP (McMahan et al. 2005), and LAO* (Hansen and Zilberstein 2001), as non-limiting examples. Of course, since the state space may be extremely large, these instantiations only manipulate partial value functions defined on the states visited so far. It is only when a new states is visited that the initialization ν(s)←h(s) is performed. The rest of this section describes the acyclic LDFS algorithm and the upper bound used by Amsaa.

See FIGS. 10(L) and 10(M) regarding functions LDFSAux(State s) and evalQ(State s, Decision x), respectively.

6.4.2. Learning Depth-First Search Functions LDFS, LDFSAux, and evalQ describe the LDFS algorithm for acyclic MDPs. LDFS requires the upper bound to be monotone, so no Bellman residual is negative. The algorithm applies LDFSAux on state s₀ until the value ν(s₀) has converged. Function LDFSAux is recursive. When LDFSAux (s) is called, there are two possibilities:
either Res_{ν}(s)=0, which means that there exists at least one decision xεχ(s) satisfying ν(s)=Q(s,x). In that case, LDFS performs a recursive call for each such decision and each of its possible transitions (lines 6-7). If these recursive calls all return true, the values of these successor states have converged and the value ν(s) has converged as well (lines 8-9). Otherwise, LDFSAux performs a Bellman update (line 10) and returns false (line 11).
or Res_{ν}(s)>0. This means s is a candidate for an update (line 5 in findAndRevise). In that case, all the tests in line 4 fail and a Bellman update is performed in line 10.

LDFS explores the state-space in an iterative deepening fashion that comes from the behavior of LDFSAux on a state s explored for the first time. Indeed, when LDFSAux(s) is called for the first time for a given state s, its value has never been updated and thus ν(s)=h(s). But the Q-values computed by evalQ (line 4) are based on values ν(s′) of each successor s′ of s. As a result, it is likely that Res_{ν}(s) will be positive, and the path exploration will not go any deeper (because of the test in line 4). This contrasts with RTDP-like algorithms, which always explore paths deeply in the state space. LDFS is an attractive algorithm for use in Amsaa for several reasons:
1. it is applicable since the problems are acyclic and a good monotone upper bound is available;
2. Amsaa's upper bound is reasonably strong but expensive to compute, justifying why the iterative deepening feature is interesting. Once the successors of a state are evaluated, the state may no longer be reachable under π_{ν} and there is no immediate benefit in further exploration.
3. the solved flags allow the algorithm to test for convergence, as opposed to RTDP;
4. its code is simpler than those of HDP and of LAO*, since it exploits acyclicity.

6.4.3. The Upper Bound h_{E}_{_{,max}} The performance of heuristic search algorithms strongly depends on the quality of the heuristic function h. A standard upper bound, that is defined for any MDP, is called h_{max,max}. For a state s, h_{max,max}(s) is the highest reward of a final state reachable from s. In other words, it corresponds to a relaxation of the problem in which the decision maker can choose not only its decisions, but also random outcomes.

For very stochastic problems, this is often a poor bound. On the standard instance of the S-RCPSP, h_{max,max}(s₀) is about 4 times the value of the optimal policy v*(s₀). Fortunately, for MDPs induced by X-MDPs, a much better heuristic function can be derived from the deterministic offline problems (see Definition 1). More precisely, for a state s, the heuristic includes solving the deterministic offline problems for the scenarios compatible with s in the original X-MDP and taking the resulting expected offline value, i.e., as shown in FIG. 10(N), where μ is ξ's distribution. Function h_{E}_{_{,max}} is a good heuristic because it leverages both the combinatorial and stochastic structures of the application. Moreover, on the approximated problem, the sets C(s) are small and the expectation can be computed exactly as a sum, which is why the approximation was introduced in the first place. It remains to show that h_{E}_{_{,max}}(s) is an upper bound for state s in the induced MDP.

THEOREM 2. Let A=(S, s₀, F, X, ⊥, χ, f, ξ, μ, τ) be an X-MDP and B be the induced MDP with transition probability function P(•|s,x). Then h_{E}_{_{,max}} is a monotone upper bound for B.

Proof. (For simplicity assume S and Ξ are finite. The theorem holds without these assumptions, but it is used in this case.) Let s be a state, and xεχ(s). Then it holds as shown in FIG. 10(O).

Now, by definition of the offline problem, one has:

∀ξεC(s),O(s,ξ)=max_{xεχ(s)}O(τ(s,x,ξ),ξ),

and thus ∀xεχ(s), O(τ(s,x,ξ),ξ)≦O(s,ξ). Therefore, the relation of FIG. 10(P) holds.

This proves that ^{Res}h_{E}_{_{,max}} for all states. Moreover, ifs is final, one has for all scenarios ξ, O(s,ξ)=f(s)=v*(s). The result follows since a value function v satisfying Res_{ν}≧0 for all states are upper bounds (McMahan et al. 2005).

### 6.5. Incrementality and Anytime Decision Making

Amsaa is an incremental algorithm: It reuses earlier computations when computing the optimal policy of a finer approximation to the original X-MDP. Its incremental nature stems from two essential components: (1) a good incremental upper bound, that is, an upper bound for the new approximation that derives from the optimal policy values of the earlier approximation; and (2) the reuse of the internal data structures. Note also that incrementality is not only beneficial for runtime performances; It is also opens the door to sequential importance sampling (Dempster 1998) and to the contamination method (Dupacova et al. 2000).

6.5.1. Incremental Upper Bound To convey the intuition behind the incremental upper bound, consider the following example under iid sampling. One has solved the approximated problem with distribution μ that gives weights ⅓ to scenarios a, b and c and one is interested in adding two scenarios d and e to obtain a solution to the finer approximation with distribution ρ in which each of these 5 scenarios has weight ⅕. Consider a state s which is compatible with a, b, and d. Assume that LDFS has shown that v*_{μ}(s)≦3, and assume O(s,d)=6. How can one compute an upper bound of v*_{ρ}(s)? If a scenario generated by ρ is in C(s), then it is in {a, b} with probability p=ρ({a,b})/ρ({a,b,d}) and is d with probability 1−p. Let ν be the probability distribution that gives probability ½ to each of the two new scenarios d and e. For the problem with distribution ρ, consider a decision maker that can query whether the actual scenario is in {a, b, c}. Depending on the answer, it will follow the policy defined by v_{μ}* or by v_{ν}*. Therefore, its expected value of s is pv_{μ}*(s)+(1−p)v_{ν}*(s). Of course, the decision maker has no access to this information: this assumption relaxes the problem, and so the expected value of this “partially clairvoyant” decision maker is an upper bound of v_{ρ}*(s). It follows that v_{ρ}*(s)≦p·3+(1−p)·6=2+2=4. The incremental upper bound theorem below formalizes this idea. To connect it with this example, note that

$$ρ = \frac{3}{5} μ + \frac{2}{5} v and ρ = 3 / 5 \cdot μ ( C ( s ) ) / ρ ( C ( s ) ) .$$

Given two distributions μ and ρ, one has that μ is absolutely continuous with respect to ρ if, for any set A such that ρ(A)=0, μ(A)=0. In that case, define the function

$$\frac{μ}{ρ}$$

by the equation of FIG. 10(Q). This function ensures that

$$μ ( A ) = \frac{μ}{ρ} ( A ) ρ ( A )$$

### for all A.

THEOREM 3. Let A, B and C be three X-MDPs that differ only by their respective distributions μ, ν, and ρ and let ρ=λμu+(1−λ)ν for some 0<λ<1. Let h_{μ} and h_{ν} be monotone upper bounds for A and B respectively. Define h:S→R by the equation of FIG. 10(R). Then h is well-defined and is a monotone upper bound for the induced MDP of C.

Proof First, h is well-defined because μ and ν are absolutely continuous with respect to ρ. Let xεχ(S) and define s′ as the random variable τ(s,x,ξ). Consider Qₕ(s,x), the Q-value in C for the value function h. One has as shown in FIG. 10(S).

Consider now the difference between h(s) and Qₕ(s,x) as shown in FIG. 10(T), where R esₕ_{_{μ}}^{A}(s) (resp. R esₕ_{_{μ}}^{B}(s)) is the residual in A (resp. A) of value function h_{μ} (resp. h_{ν}) These residuals are non-negative because h_{μ} and h_{ν} are monotone, Since this inequality holds for all x, it follows that Resₕ(s)≧0. This proves the monotonicity of h, that h is also an upper bound.

Amsaa applies this theorem as follows. The empirical distribution of the X-MDP used in the previous iteration is μ and the empirical distribution of the new scenarios is ν. An optimal policy for A has been computed with the upper bound h^{μ}_{E}_{_{,max}} (the bound h_{E}_{_{,max}} for the problem with distribution μ) and the returned value function v_{A} is a monotone upper bound for A which is optimal for all states reachable under policy πᵥ_{_{A}}. The function v_{A} corresponds to h_{μ} in the theorem. The function h_{ν} is h^{ν}_{E}_{_{,max}} and is computed by solving the offline problem on each new scenario. When the number of new scenarios is small compared to the previous sample size, the incremental upper bound h is:
optimal for any state s reachable under πᵥ_{_{A}} satisfying ν(C(s))=0;
tight for most states s reachable under πᵥ_{_{A}}, because the term

$$( 1 - λ ) \frac{v}{ρ} ( C ( s ) )$$

h^{ν}_{E}_{_{,max}} will be usually small compared to

$$λ \frac{μ}{ρ} ( C ( s ) ) {v}_{A} ( s ) ;$$

at least as good as h^{ρ}_{E}_{_{,max}} everywhere because v_{A}(s)≦h^{μ}_{E}_{_{,max}}(s) for all states s.

Computing

$$λ \frac{μ}{ρ} ( C ( s ) ) or ( 1 - λ ) \frac{v}{ρ} ( C ( s ) )$$

for a state s is easy. In the case of iid sampling, it suffices to count how many scenarios in C(s) are present in the earlier iteration and how many are being added. For example, if μ is based on 90 scenarios and ν on 10, then

$$λ \frac{μ}{ρ} ( C ( {s}_{0} ) ) = \frac{90}{90 + 10} \cdot \frac{1.0}{1.0} = 0.9$$

at the root node. Obviously, this theorem is most useful for states s where

$$λ \frac{μ}{ρ} ( C ( s ) )$$

is close to one.

6.5.2. Objects reuse To make efficient use of this incremental upper bound, Amsaa may reuse data structures created when solving A. Indeed, when adding a small number of new scenarios, only a small number of states will be affected and it would be inefficient to compute the incremental upper bound of all explored states. Instead Amsaa may update states lazily. The iterative refinement define a sequence of X-MDPs A₁, . . . , Aₙ, . . . . Each state may store a time stamp, for example, an integer i stating that the stored information is valid with respect to Aᵢ. When an out-of-date state is encountered (its time stamp is smaller than the index of the current X-MDP), it is updated.

### 7. THEORETICAL RESULTS ON THE SAMPLING AVERAGE APPROXIMATION FOR X-MDPs

The SAA method was developed for stochastic programs. Fortunately, several results for multistage programs can be adapted to X-MDPs. Two such results are presented.

The first result is important to evaluate the solution quality of Amsaa. Indeed, The SAA method provides a positively biased estimator for the objective value of stochastic programs. This stems from the fact that the same sample is used to find a policy and to evaluate it, which Mak et al. (1999) calls appropriately “inside information”, producing decisions optimized for the sample, not for the whole scenario space. The following theorem extends this result to X-MDPs. Some technicalities, in particular the fact that the number of scenarios compatible with a given state is random, pollute this otherwise simple proof.

THEOREM 4 (Positive bias). Let A be a finite-horizon X-MDP and denote by Âₙ the random X-MDP obtained by sampling n replications ξ¹, . . . , ξⁿ of ξ (independence is not required). For a state sεS, denote by \hat{υ}ₙ(s) the value of s in Âₙ when it exists. Then, for any nεN, one has as shown in FIG. 10(u).

Proof First, define the stage of a state s as T, the horizon, minus the highest number of transitions from s to a final state in A. The proof establishes the following property by induction on the stage t: “Let sεS be a state at stage t such that #Cₙ(s)=k. For all 0<k≦n, E[\hat{ν}ₙ(s)|#Cₙ(s)=k]≧ν(s)”

All final states satisfying \hat{υ}(s)=f(s)=υ(s), the property holds at the last stage T. Consider now a stage t<T and suppose the property holds at t+1. Consider a random sample problem Âₙ and a state s in stage t that is non-final in A and such that #Cₙ(s)=k. Denote the scenarios in Cₙ(s) by ξ^{s,1}, . . . , ξ^{s,k} and define for xεx(s) as shown in FIG. 10(V), where s^{x,i}=τ(s,x,ξⁱ). By definition of max, one has ĝ(x′)≦max_{xεχ(s)}ĝ(x) for all x′εχ(S). By taking a conditional expectation on both sides, one obtains as in FIG. 10(W), and by taking the max over x′, one has as in FIG. 10(X). Now, one has as in FIG. 10(Y), and, by linearity, as in FIG. 10(Z). Decompose this last conditional expectation as shown in FIG. 10(AA).

Now, thanks to the Markov property for X-MDPs, \hat{υ}(s^{x,i}) is independent of Cₙ(s) \ Cₙ(s^{x,i}), so one can apply the induction hypothesis to the inner expectation for each possible value of #Cₙ(s^{x,i}), as in FIG. 10(AB), and, because the scenarios are replications of ξ, one has as in FIG. 10(AC). Combining the equations of FIGS. 10(Z) and 10(AC) leads to that of FIG. 10(AD).

This shows that the induction property holds for state s in stage t. The theorem follows from the property at state s₀ and because # Cₙ(s₀)=n.

The second result is mostly of theoretical interest. Let A be an X-MDP, ν be its optimal value, and X⊂χ(s₀) be the set of optimal initial decisions. Define equally \hat{υ}ₙ and \hat{X}ₙ as the optimal value and set of optimal initial decisions of the random X-MDP A_{μn}. The SAA theory is concerned with the convergence of \hat{υ}ₙ to ν and of \hat{X}ₙ to X in appropriate senses. The following theorem proves this convergence when Ξ is finite, generalizing a well-known results from stochastic programs to XMDPs. Unfortunately, the proof requires more scenarios that there are in Ξ, defeating the purpose of sampling. For this reason, the proof is only sketched.

THEOREM 5 (Estimator Consistency). Let A be an X-MDP such that Ξ is finite, and Âₙ the random X-MDP obtained by iid sampling of n scenarios. Then, almost surely one has as in FIG. 10(AE).

Proof (Sketch) This theorem relies on the strong law of large numbers. Consider, for xε•(s₀), the value Q(s₀,x) of x in A, and similarly the value \hat{Q}ₙ(s₀, x) of x in Âₙ. Recall that ν=max_{x′εω(s}_{₀}₎ Q(s₀, x) and \hat{υ}ₙ=max_{xεχ(s}_{₀}₎ \hat{Q}ₙ(s₀, x). It will be proven that for all xεχ(s₀), \hat{Q}ₙ(s₀, x) converges almost surely to Q(s₀,x). By finiteness of χ(s₀), this implies as shown in FIG. 10(AE) (top).

Moreover, let ε>0 be such that, for all xεχ(s₀), either Q(s₀,x)=ν, or Q(s₀,x)<ν−3ε. If all the \hat{Q}ₙ(s₀, x) converge almost surely, then there is a random variable N such that ∀xεχ(s₀), ∀n≧N, |\hat{Q}ₙ(s₀,x)−Q(s₀,x)|<ε, and N is almost surely finite. Let n>N. For any xεX one has \hat{Q}ₙ(s₀,x)<Q(s₀,x)+ε<ν−2ε and, for any yεX and n≧N, \hat{Q}ₙ(s₀,y)>Q(s₀,y)−ε>v−ε. It follows that \hat{Q}ₙ(s₀,x)−\hat{Q}ₙ(s₀,y), and so xεXₙ. Hence, proving that the \hat{Q}ₙ(s₀,x) converge almost surely also implies as shown in FIG. 10(AE) (bottom).

It remains to prove that the \hat{Q}ₙ(s₀,x) converge almost surely. Thanks to the strong law of large numbers, one has for all sεS, and ZεΞ as shown in FIG. 10(AF) and the proof is a backward induction on the property that \hat{υ}ₙ(s)→υ(s) using this fact.

### 8. EXPERIMENTAL RESULTS

This section describes the experimental results on Amsaa and is organized in four main parts. First are reported experimental results about the quality of the decisions produced by Amsaa and several other algorithms under various time constraints. Amsaa's behavior is then considered in more detail and its computational complexity and convergence in practice are discussed. A comparison of Amsaa and a mathematical programming approach to solve the SAA problem is then given for completeness. Finally, Amsaa is compared to gap-reduction techniques for one-step anticipatory algorithms.

### 8.1. Quality of Anytime Decisions

8.1.1. Experimental Setting The benchmarks are based on the collection of 12 instances for the S-RCPSP from (Choi et al. 2004) described below. For each instance, 1,000 realizations of the uncertainty were generated. A run of an algorithm on a realization consists of simulating one trajectory in the X-MDP. At each encountered state, the online algorithm takes a decision with hard time constraints. If the online algorithm has not enough time to decide, a default decision, closing the labs, is applied. The algorithms were tested on all the realizations and various time limits. With 4 tested algorithms and time limits of 31 ms, 125 ms, 500 ms, 2 s, 8 s, and 32 s, this gives a total of 288,000 runs.

With more than 10 decisions on average per run, this represents more than 4×12×1000×(31 ms+125 ms+0.5 s+8 s+32 s)×10=2,000 hours of cpu time.

The 12 Instances The benchmarks are based on the collection of instances for the S-RCPSP (Choi et al. 2004) defined in (Dooms and Van Hentenryck 2007). The reference instance has two laboratories and 5 projects, each of which have 3 or 4 tasks, giving a total of 17 tasks. The number of realizations for each task range from 3 to 7, giving a total of 1.2·10⁹ possible scenarios.

The different variants are the following:
1. Reg: the reference instance;
2. Agr: the various realizations of a given task corresponding to a failure (resp. success) are merged into a single realization, whose cost and duration are the averages of the original realizations. In other word, each task has a most two realizations, one for success and one for failure.
3. Cost2 and Cost5: the costs of the tasks are scaled by a factor 2 and 5 respectively.

4. D.6 and D1.5: the revenue for completing a project at time t in D.6 (resp. D1.5) is the one for completing the same project at time t/0.66 (resp. t/1.5) in instance Reg.

5. PX (P1, P2, P3 and P4): The last Xtasks of each project do not fail. For instance, in P3, 3-task projects never fail and 4-task projects can only fail at the first task.

6. R.6 and R1.5: the revenues are scaled by a factor 0.66 and 1.5 respectively (equivalent to choiCost1.5 and choiCost0.66).

These instances explore various tradeoffs between the combinatorial and stochastic aspects and specific algorithms may exhibit radically different behaviors on some of them. Note that Cost5 is a pathological instance for which it can be proven that the optimal policy is to schedule no project.

The Compared Algorithms. Experimental results are reported for four algorithms implemented in Java and sharing significant code.
Amsaa is used with iid sampling and sample sizes growing by increments of 10%. It uses the branch and bound algorithm from (Dooms and Van Hentenryck 2007) which is described below.
1s-AA is the one-step anticipatory algorithm with iid sampling. It uses the same offline solver as Amsaa.
B-RTDP is a variant of the Bounded Real-Time Dynamic Programming algorithm (McMahan et al. 2005), in which the decision is taken greedily with respect to upper bounds, instead of lower bounds as in the original algorithm. The lower bound h⁻(s) correspond to scheduling no project after state s. The upper bound is h⁺(s) is a very slight relaxation of h_{max,max}: It uses the offline solver on an hypothetical best scenario in which tasks realizations have the smallest cost and the smallest duration of all realizations with non-zero probability. It was also tried using h_{max,max}, but could not find a better algorithm than enumerating the Pareto frontier of scenarios with non-zero probability, which is very slow. As a result, for anytime decision making, the relaxation of h_{max,max} produces much better decisions. The original B-RTDP algorithm was tried, taking decisions with respect to lower bounds. These results are not reported here because, on most instances, the algorithm does not schedule any project within the time constraints. Taking decisions with respect to upper bounds, as in (not bounded) RTDP algorithms, is much better on this problem.
HC-DP is the Heuristically-Confined Dynamic-Programming algorithm from Choi et al. (2004) enhanced into an anytime algorithm. The original algorithm uses an offline learning phase, common to all the runs, to obtain a policy used during execution. The policy, computed by dynamic programming, is the solution of a restricted MDP whose state space consists of those states reached by running 3 heuristics on 50,000 scenarios each. During execution, the algorithm follows this learned policy, with some basic recourse heuristic when reaching a state outside the confined space. The anytime version of this algorithm proposed in (Dooms and Van Hentenryck 2007) is used. When given 32 seconds per decision, this new version significantly outperforms the original algorithm on all instances but Cost5 on which both versions produce the same result.

The Offline Optimization Algorithm. Amsaa, 1s-AA, and B-RTDP all use offline solver based on branch and bound algorithm for the S-RCPSP Dooms and Van Hentenryck (2007). The upper bound in the algorithm relaxes the resource constraints. Its branching procedure is chronological and always schedules a task as soon as a laboratory is available. A preprocessing step removes jobs not worth scheduling and factors out costs into the rewards. This offline solver, implemented in C, solves offline problems sampled at the root node of instance Reg in less than 1 ms on average.

A Note on Modeling. The MDP used by B-RTDP and by HC-DP is not the MDP induced by the X-MDP used by Amsaa. Section 5.5 explained why. Indeed, when modeling the S-RCPSP as an X-MDP, it is necessary to store all the past task realizations to satisfy the Markovian property. This is not the case when modeling the problem as an MDP. As a result, the MDP used by B-RTDP and HC-DP has a smaller state space than the X-MDP used by Amsaa.

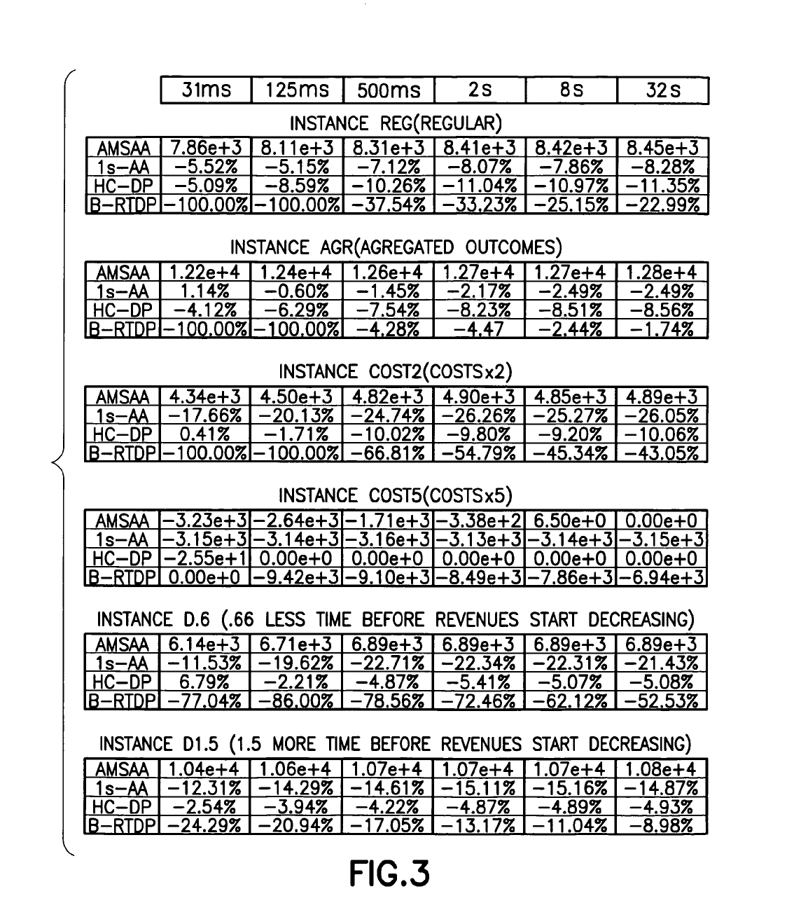

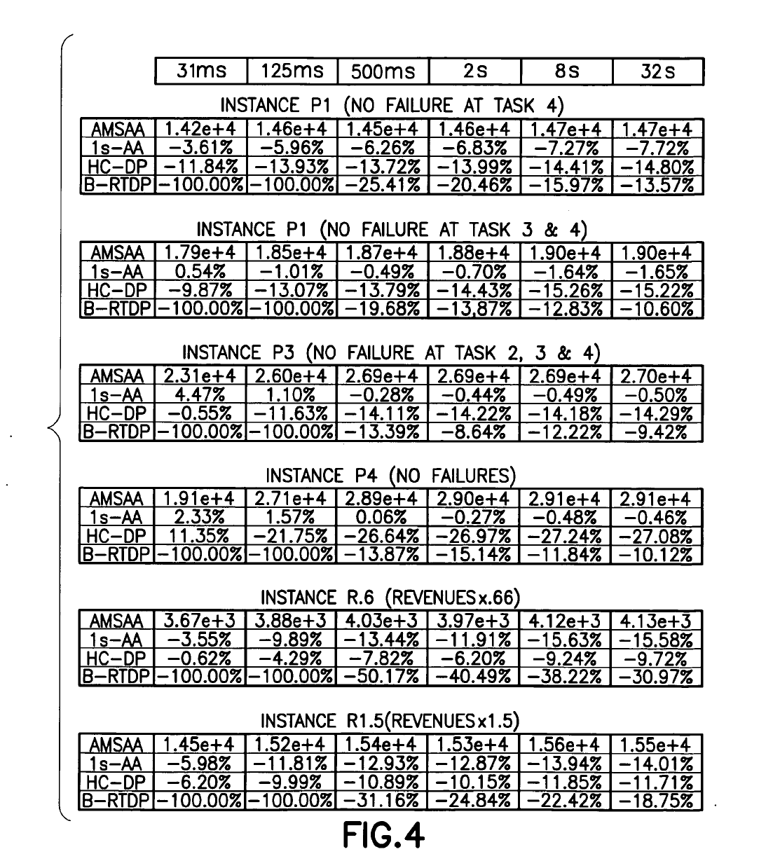

8.1.2. Comparison of the Decisions Quality FIG. 3 illustrates exemplary experimental results for anytime decision making on the S-RCRSP. FIG. 4 shows further exemplary experimental results for anytime decision making on the S-RCRSP. FIGS. 3 and 4 summarize the results for anytime decision making. They contain a table for each of the 12 instances. The first line of this table contains the empirical mean value obtained by running Amsaa. The three lines below report the relative gap between the expected value of the considered algorithm and Amsaa with the same time constraint (except for Cost5, for which the expected value is reported for all algorithms). In addition, the background color carries information about the statistical significance of the results, at the 5% level. It indicates whether the considered algorithm is better than Amsaa-32 s (no occurrence here); not worse than Amsaa-32 s (dark gray, e.g., Amsaa-500 ms on Cost2); significantly worse than Amsaa-32 s, but better than Amsaa-31 ms (gray, e.g., 1s-AA-31 ms on P3); worse than Amsaa-32 s, but not than Amsaa-31 ms (light gray, e.g., B-RTDP-2 s on Agr); or worse than Amsaa-31 ms (white, e.g., HC-DP-32 s on Reg).

Overall Amsaa exhibits excellent performance. The solution quality of Amsaa-32 s is often higher by at least 10% than 1s-AA-32 s, HC-DP-32 s, and B-RTDP-32 s, and is robust across all instances. With 32 s, Amsaa is significantly better than all other algorithms on 11 instances and as good as any other algorithm on Cost5. Moreover, the remaining three algorithms lacks robustness with respect to the instances: They all rank last at least once. Note that, on Cost5, the optimal policy is to schedule no project. HC-DP is able to realize that quickly because it uses very fast heuristics. Amsaa-32 s and HC-DP with at least 125 ms are also optimal on this problem.

Amsaa is also robust with respect to the available computation time. On most instances, the rankings of the four algorithms do not vary much with respect to the computation times. One might think that with very strong time constraints, 1s-AA is preferable to Amsaa, because 1s-AA can use more scenarios in the same amount of time. Yet, there are only two instances on which 1s-AA-31 ms beats Amsaa-31 ms (Agr and P3) and 3 on which they exhibit similar results. Note that B-RTDP-31 ms has a zero score on many instances due to the fact that even a single B-RTDP trial has to go deep in the state space and compute the bounds h⁺ and h⁻ for many states. Under such strict time constraints, B-RTDP cannot even perform one trial before the deadline.

### 8.2. Complexity and Convergence of Amsaa

The behavior of Amsaa is now studied experimentally.

8.2.1. Empirical Complexity of Amsaa First consider the empirical complexity of Amsaa.

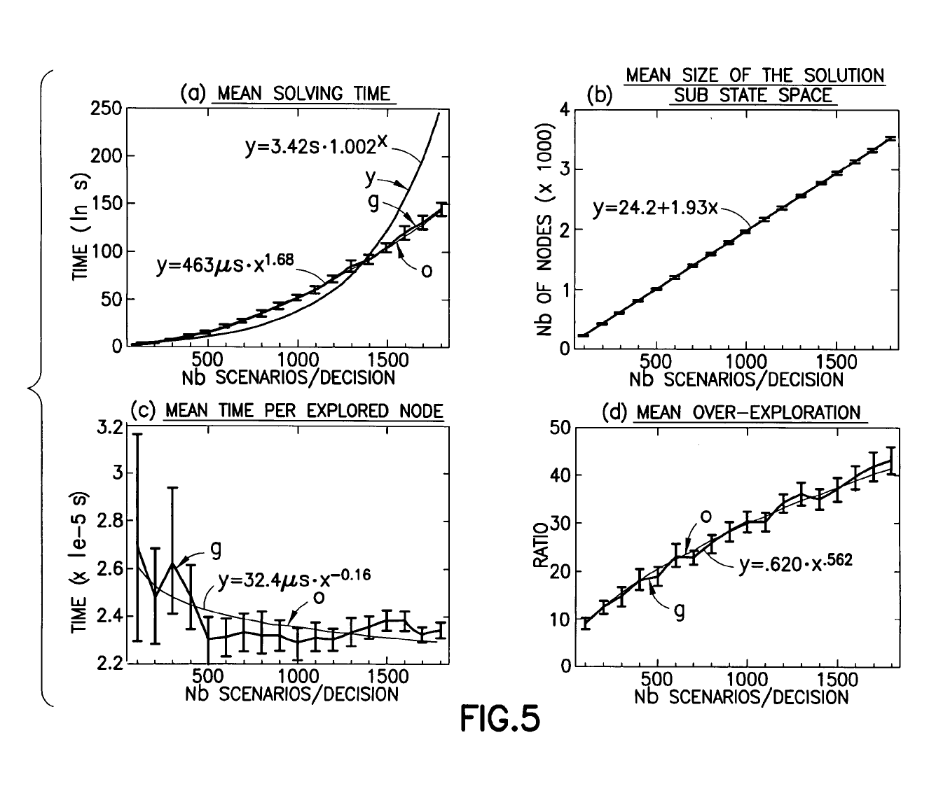

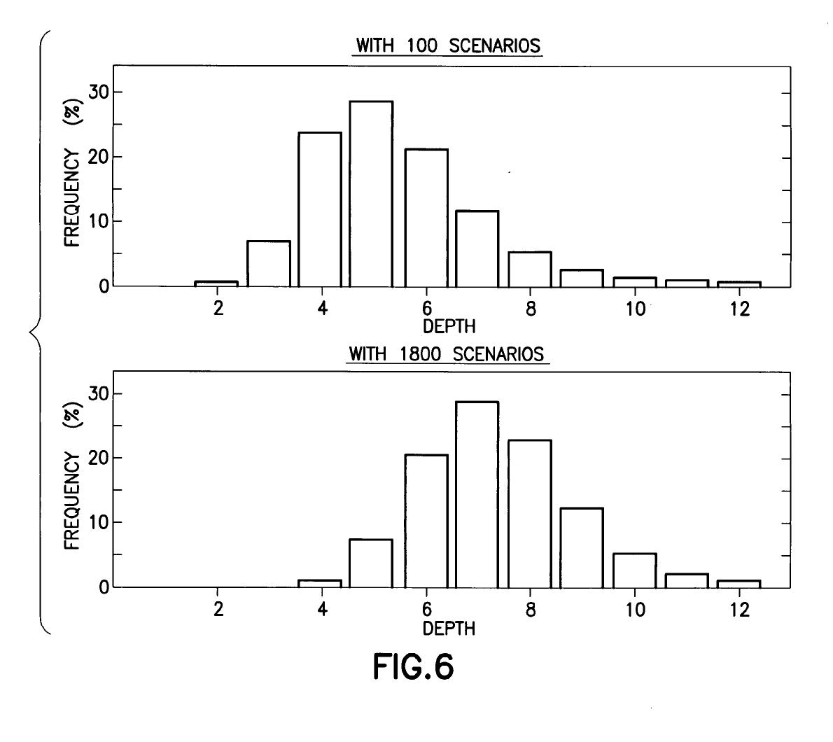

FIG. 5 illustrates exemplary runtime behavior of Amsaa for the initial decisions on Reg. FIG. 6 shows an exemplary distribution of the depth of explored nodes by Amsaa for the initial decision.

FIG. 5 depicts various experimental results obtained from 20 runs of Amsaa on instance Reg for different numbers of scenarios per decision (from 100 to 1800 by steps of 100). Focus on initial decision which is by far the most difficult and takes almost half of the time of a run. On each subfigure, the line with intervals for each data point depicts the empirical mean of the measured data, as well as a 95% confidence interval. The smooth lines depict the values predicted by fitted models. The models used have at most 2 parameters to learn so that the fit can be considered excellent when the prediction lies in the confidence interval for the 18 empirical measures.

FIG. 5(a) reports the mean execution time to solve the initial SAA problem. Because Amsaa is exponential in the worst case, it is tempting to fit an exponential model y=a·bⁿ. The best fit for such a model is shown by the light green line (g), which lies outside the confidence intervals of many data points: This model can be ruled out. The orange line (o) depicts a power model of the form y=a·n^{b} which is an excellent fit and has small exponent (1.68). Therefore, on this problem, Amsaa is largely subquadratic in the number of scenarios.

However, one may argue that this behavior may be a consequence of iid sampling and is not a convincing evidence that Amsaa exhibits good performance. Indeed, in the case of a continuous distribution of the uncertainty, all the scenarios would almost surely be dispatched to different states after the first observation and Amsaa with iid sampling would have a linear complexity. The stochastic RCPSP has finite distributions but a similar behavior, i.e., a fast divergence of the scenarios, may explain its good performance. Obviously, Amsaa produces better decisions than other approaches but it is still interesting to address this issue convincingly.

On stochastic programming problems, thanks to pure exogeneity, this concern could be addressed by looking at the topology of the scenario tree (e.g., its depth and the number of nodes). There is no scenario tree for X-MDPs, but a natural generalization of this metric to X-MDPs is the number of nodes in the solution state-space. More precisely, the idea is to count, upon termination on Amsaa, the number of the states reachable in Âₙ by following the optimal policy. This is the metric depicted in FIG. 5(b). With a continuous distribution, the number of nodes in the solution state space would almost surely be n+1 for n scenarios: the root node and n leaves. In the case of Bernoulli random variable with parameter one half, the solution state space would be a roughly balanced binary tree with 2m−1 nodes. These two extreme cases suggest to fit a linear model of the form y=a+bn. Such a model fits perfectly the experimental results with a slope of 1.93, making it much closer to a Bernoulli case than to a continuous distribution. This is an evidence that, because of the finite distributions, scenarios do not diverge too quickly with iid sampling and that the SAA problem become significantly harder with the number of scenarios.

Consider now the decomposition of the runtime as shown in FIG. 10(AG).

FIG. 5(c) shows how the runtime per explored node evolves. The runtime per explored nodes decreases slowly when the number of scenarios increases. This can be explained by the fact that, with more scenarios, a greater proportion of nodes are deep, making offline problems easier. This hypothesis is confirmed in FIG. 6. It should be noted that the power model does not fit well the runtime per explored nodes. Finally, the over-exploration, that is, the ratio of the number of nodes explored by Amsaa over the number of nodes in the solution state space, is depicted in FIG. 5(d). The over-exploration does grow, but quite slowly and with an exponent of 0.56.

In summary, Amsaa is very scalable with iid sampling, although the difficulty of the SAA problems does grow significantly.

8.2.2. The Importance of the Upper Bound Consider now the benefits of the upper bound h_{E}_{_{,max}} over the simpler bound h_{∞} defined by h_{∞}(s)=f(s) if f is final, +∞ otherwise. Remember that, for the induced MDP, a state s is final if #C(s)=1, so h_{∞} still calls the offline solver at the leaves. Heuristics h_{∞} can only be used in Amsaa with few scenarios: the size of the state space quickly exceeds the size of the available memory. The table of FIG. 10(AH) reports results using 10 to 50 scenarios based on 10 SAA problems.

The results show that h_{E}_{_{,max}} is effective in limiting the size of the explored state space and that the benefits increase with the number of scenarios. In particular, Amsaa with h_{E}_{_{,max}} explores 360 (resp. 590) times fewer nodes than Amsaa with h_{∞} for 10 (resp. 50) scenarios. This clearly justifies the use of the offline problems.

Other heuristics with great potential for Amsaa could be built from upper bounds to the offline problem. More precisely, if a function g satisfies g(s,ξ)≧O(s,ξ), then the heuristic for non-final states could be E[g(s,ξ)|EεC(s)]. Such heuristics might be cheaper to compute, while retaining much of the accuracy of h_{E}_{_{,max}}. Moreover, such an approach recognizes that it is easier to design good upper bounds for deterministic problems than for their stochastic versions.

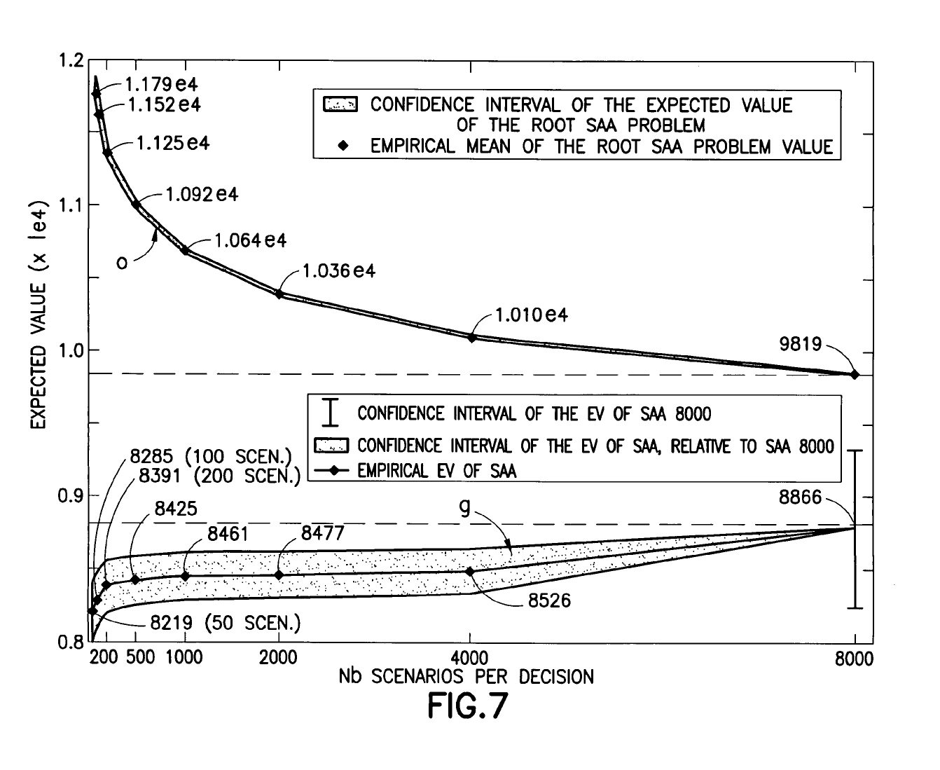

8.2.3. Convergence of the Sampling Average Approximation Section 6.2 described theoretical results on the SAA method for X-MDPs. It did not discuss the rate of convergence of the estimators such as \hat{υ}ₙ(s₀), which is not surprising since few results are known even for multi-stage stochastic programs (Shapiro 2006). Instead consider the presented empirical results about the convergence of the SAA estimators based on 1000 realizations of instance Reg and a number of scenarios per decision taken from {50, 100, 200, 500, 1000, 2000, 4000, 8000}. Amsaa was executed once for each pair (number of scenarios, realization). The experimental results study the convergence of the expected value, the SAA upper bound, and the selected decisions. This section is thus purely concerned with the sampling average approximation, not the way sample problems are solved. FIG. 7 depicts convergence of the SAA expected value and upper bound.

Convergence of EV and of E[\hat{υ}ₙ(s₀)]. FIG. 7 reports the expected objective value (EV) of these runs and an estimation of the expected SAA value E[\hat{υ}ₙ(s₀)] which is an upper bound on the optimal expected value ν(s₀) (see Theorem 4). Measuring the expected objective values accurately is difficult because of the high variance. The figure depicts a 95% confidence interval on the EV of Amsaa with 8000 scenarios per decision; the interval size is about 1,000, more than 10% of the empirical EV. This variance is inherent to the problem, not a defect of Amsaa. Any other reasonable policy will exhibit a high variance. The confidence intervals are so wide that no conclusion can be drawn about the convergence of the expected objective values by comparing them. Instead, the confidence intervals of the differences between the expected values of Amsaa for n scenarios and Amsaa with 8,000 scenarios are plotted. Because the set of 1,000 realizations was the same for the different number of scenarios considered, the variances of these differences are much lower than the variances of the objective values themselves. The green area (g) in the figure is the set of values that differ for the empirical EV of Amsaa-8000 by a quantity within a 95% confidence interval of the expected difference. In other terms, although one cannot claim that the expected objective value of Amsaa for a varying number of scenarios lie in the green area (g), each point will have at least 95% chance of being in the region obtained by shifting the green area (g) vertically so that it ends at the expected value of SAA 8000.

The optimality gap measures how close these values are from the limits. The optimality gap is not greater than the difference between the SAA upper bound (that is, E[\hat{υ}ₙ(s₀)]) and the EV s. The orange area (o) on FIG. 7 represents 95% confidence intervals on E[\hat{υ}ₙ(s₀)]. First observe that the E[\hat{υ}ₙ(s₀)] can be measured very accurately: for Amsaa-8000, the confidence interval is [9885 . . . 9897], less than 0.13% wide. The quantity E[\hat{υ}ₙ(s₀)] varies much less than the EV s because it concerns an agglomeration of many scenarios, while the value of a run is strongly dependent of the actual realization. Because this upper bound is obtained from the first SAA problem and because fewer runs are necessary due to the low variance, it is possible to obtain a confidence interval for this upper bound given by Amsaa-32,000 in reasonable time using only 50 runs: E[̂v32,000(s0)] lies in [9, 618 . . . 9, 647] with probability at least 95%. In contrast, it is not computationally reasonable to execute full runs of Amsaa-32,000 for all the 1000 realizations. For Amsaa-8000, the EV is within 2% to 14% of E[\hat{υ}_{32,000}(s₀)] and hence within 14% of the optimal value EV*. This means that more scenarios are needed for the convergence of either EV, the SAA upper bound, or both. FIG. 7 unfortunately does not rule out any of these possibilities. Yet the regularity of the graph for E[\hat{υ}ₙ(s₀)] tends to suggest that its value will continue to decrease beyond 32,000 scenarios, so the 14% optimality gap is probably pessimistic.

The EV s show a curious behavior investigated below: they grow only slowly from 500 to 4000 scenarios. Amsaa-4000 is even not better than Amsaa-2000 at the 5% significance level. Yet Amsaa-8000 is much better than Amsaa-4000 at the 10⁻⁵ significance level. This empirical study confirms that the convergence of SAA estimators for X-MDPs is much more complex than for two-stage problems. Keep in mind however that in an operational setting, what matters is anytime performance rather than the convergence.

Convergence of the Selected Decisions. Consider now the convergence and stability of Amsaa decisions on instance Reg. Focus on the first and second decisions, which correspond to the two projects scheduled at time 0, one for each laboratory. Table 1 (see FIG. 10(AI)) shows the convergence of decisions in Amsaa on instance Reg. Table 1 reports the number of times (out of 1,000 runs) a given project was selected in the first and second times as a function of the number of scenarios. The first decision seems to converge quickly: The same project is always selected from 500 scenarios. The second decision is more interesting: Project C is almost always chosen from 200 to 2000 scenarios. However, the decision switches to project D for 8000 scenarios, explaining why the expected value, which seemed to have converged at 4,000 scenarios, rises significantly from 4,000 to 8,000 scenarios. This odd behavior is due to the multistage nature of the problem: on two-stage problems, the estimation of each decision quickly becomes normally distributed and the convergence to the right decision is exponentially fast. On a multi-stage problem, additional sampling triggers new non-anticipativity constraints, possibly creating more complex behaviors.

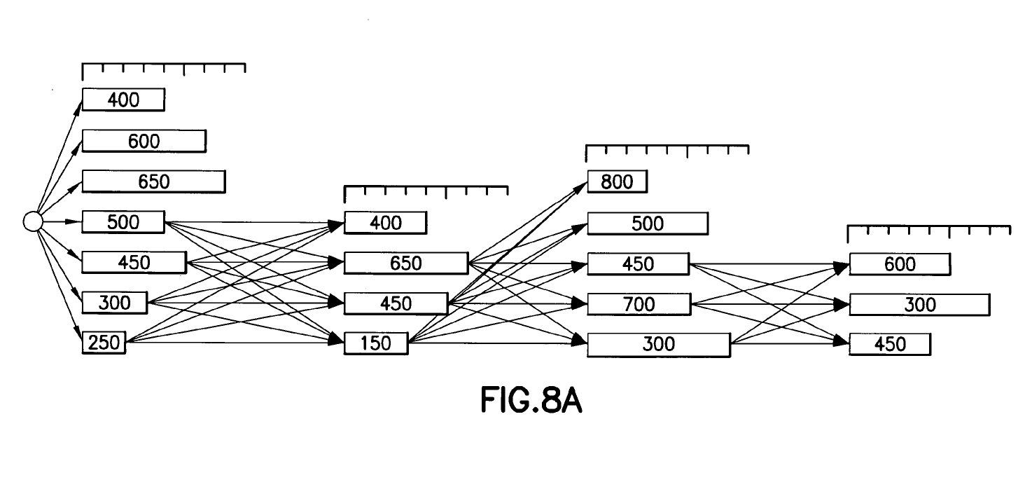

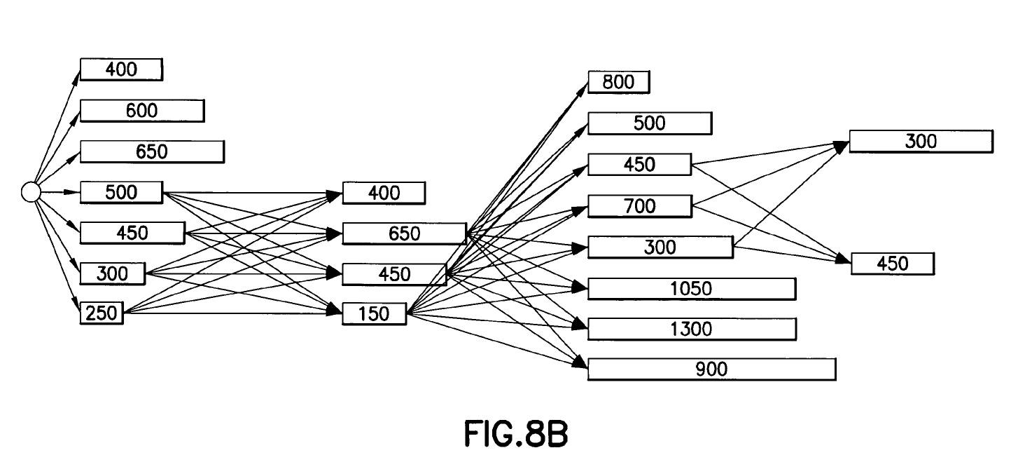

In FIG. 8, The thickness of the arrows is proportional to the transition probability. Failed tasks have a shaded backgroung. The numbers inside the rectangles indicate their costs, and the lengths of the rectangles indicate durations. In ProjCSimpl, the project C never fails at task 4. New realizations are added for task 3 which, in cost and duration, are equivalent to one realization of task 3 in choiNormal followed by the failed realization of task 4. Transition probabilities to these new realizations are the product of the corresponding transition probabilities in choiNormal between task 2 and 3 and between task 3 and 4.

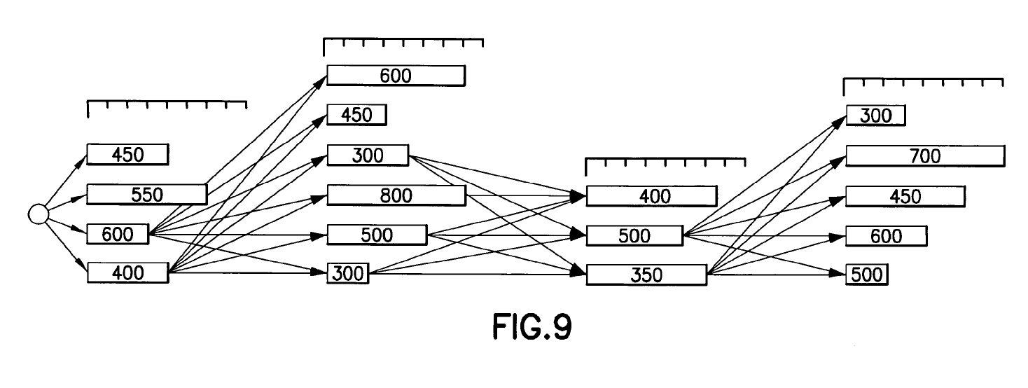

FIG. 8(a) illustrates an exemplary project C on Reg. FIG. 8(b) depicts the exemplary project C in Reg. and in an exemplary simplified instance. FIG. 9 shows an exemplary project D in Reg.

Can one confirm that non-anticipatory constraints are indeed responsible for this phenomenon? Maybe so. Consider this project C, which seems attractive at first but becomes less attractive with more samples. Its structure is depicted in FIG. 8(a). Observe that, when task 3 succeeds with cost 450 or 700, there is a high uncertainty about the success/failure of task 4: Two arrows exiting the realization of task 3 of cost 400 have similar thickness. Project D did not show that structure, as depicted in FIG. 9. This switch in the second decision may be explained by the non-anticipativity constraints from the realization of task 3 in this project, which might be missing with fewer scenarios. First, observe that the average depth of the leaves of the solution subtree moves from 7.2 to 8.1 when the number of scenarios increases from 4,000 to 8,000 on this instance. This depth increase can cause the SAA sample to contains scenarios indistinguishable until the observation of task 3 of project C. Second, the hypothesis was tested on a new instance ProjCSimpl, which is identical to Reg, except that project C is replaced by the one depicted in FIG. 8(b). In this instance, task 4 of project C never fails and new realizations are added for task 3. The transition probability were corrected to make the new instance as close as possible as Reg, while allowing the failure at task 4 to be recognized one step earlier. In particular, the expected offline values are exactly the same for Reg and ProjCSimpl, as are the expected value of the optimal policy for the problems consisting of only the project C, simplified or not. If the hypothesis is correct, the second decision should also switch from project C to project D, but with fewer scenarios than on Reg. The following table show the first and second decisions on 1000 runs on ProjCSimpl. The table does show a faster switch to project D. Although this experiment does not prove that the non-anticipativity constraints after observing task 3 of project C is the only reason for the switch, it does show that it plays a role in the phenomenon.

### 8.3. A Mathematical Programming Approach

Stochastic programming traditionally focuses on purely exogenous problems. However, Goel and Grossmann (2006) recently proposed an integer programming (IP) formulation of a Stoxuno problem (which they presented as an endogenous problem). This section evaluates a similar approach for the stochastic RCPSP using their model (P2). Start by describing the model in some detail and then compare the approach to Amsaa. The presentation of the IP is not self-contained: it will refer to notations and constraints from Goel and Grossmann (2006). It can be skipped in a first reading, the comparison does not require a deep understanding of the model.

8.3.1. An Integer Program for the SAA problem The model (P2) is directly adapted from (Goel and Grossmann 2006) and uses the same notations. The decision variables in the model correspond to scheduling decisions for a task in a scenario:
x_{s,j,i,t}: binary. x_{s,j,i,t}=1 if and only if (iff) the task i of job j starts at time t in scenario s. The model also uses some auxiliary variables to state the constraints:
b_{s,j,i,r,t}: binary. b_{s,j,i,r,t}=1 iff, at time t in scenario s, whether or not the realization of task i of job j is of index r is revealed. That is, until time t−1, both possibilities were possible and, at time t, either the task (j, i) terminates and the realization is revealed, or the task does not terminate but the time for which it has been running excludes realization r.
Zₜ^{s,s′} for s<s′: binary. Zₜ^{s,s′}=1 iff scenarios s and s′ are indistinguishable at time t.

The objective function is as shown in FIG. 10(AK), where rwd(j, t) is the revenue obtained by successfully completing job j at time t, nbTsk(j) is the number of tasks in job j, lastTaskDur(s,j) is the duration of the last task of job j in scenario s, and cost(s,j,i) the cost of task (j, i) in scenario s. The problems-specific constraints (equivalent of constraints 3, 4, 5 in (P2)) are:

Start-time uniqueness constraints: Tasks can be scheduled zero or one time (it is allowed to drop a project), that is, ∀s, j, i, Σₜx_{s,j,i,t}≦1;

Cumulative resource constraints: ∀t, ξ_{(s,j,i,t′)εrunning(t)}x_{s,j,i,t′}≦(nbr. of labs), where running(t) is the set of quadruplets (s, j, i, t)′such that if, in scenario s, task (j, i) starts at t′, it runs at time t;

Precedence constraints: ∀s, t, j, i, x_{s,j,i+1,t}≦Σ_{t′εearly(s,j,i,t)}x_{s,j,i,t′}, where early(s,j,i,t) is the set of t′ for which task (j, i) is completed by t if it starts at t′ in scenario s;

Information acquisition constraints: These are the constraints linking the b's and the x's. Let Δ_{s,j,i,r} be the time gap between the start time of task (j, i) in scenario s and the observation of whether or not this task has realization r. Δ_{s,j,i,r} is the minimum of the duration of actual realization if task (j, i) in scenario s and of the duration of realization r of task (j, i), so it can be computed a priori. The constraints then read: ∀s, j, i, r, t, b_{s,j,i,r,t}=x_{s,j,i,(t-Δ}_{_{s,j,i,r}}₎. The rest of the constraints are exactly the same as in (P2), that is:

Non-anticipativity constraints: ((17) in (P2)). ∀s, s′, t, j, i, (Zₜ^{s,s′}=0) [symbol] (x_{s,j,i,t}=x_{s′,j,i,t}). This is easily linearized since all variables are binary. Following (P2) precisely would also require adding the constraints ∀s, s′, t, j, i, (Zₜ^{s,s′}=0) [symbol] (b_{s,j,i,r,t}=b_{s′,j,i,r,t}). These are implied by earlier constraints in this case.

Indistinguishability constraints: ((18) in (P2)).

∀s, s′s, t, (Zₜ^{s,s′}=1) [symbol] _{t′≦t,j,i}(b_{s,j,i,r,t′}=0).

8.3.2. Performance and Comparison with Amsaa The number of binary variables in the proposed IP grows quadratically in the number of scenarios, since there is a Z-variable for each time t and each pair of scenarios. For instance, the model sizes, before (and after) the CPLEX presolve, for three iid samples with respectively 5, 10, and 20 scenarios are as in FIG. 10(AL).

The numbers do not show quadratic growth because, for small number of scenarios, there are roughly the same number of x- and b-variables than Z-variables. Still the resulting models are of considerable size. CPLEX 10.1 did not find the optimal integer solution within 10,000 seconds, whereas Amsaa solves this problem in 0.1 second. On the problem with 20 scenarios, with all parameters at their default value, the presolve takes one hour, and CPLEX runs out of memory before the first integer solution is found. In contrast, Amsaa handles 1,000 scenarios easily. With 1,000 scenarios, the IP would have about 10⁸ binary variables (since the number of time steps is about 100 and thus (10³)²×100=10⁸). Such a problem is completely unreasonable for today's IP solvers. Goel and Grossmann (2006) acknowledge that the IP cannot directly be solved by an IP solver and suggest a branch and bound algorithm based on a Lagrangian relaxations of the non-anticipativity constraints. Yet, with 1,000 scenarios, such a branch and bound algorithm relaxes about 10⁹ constraints (there are about 10 non-anticipatory constraints for each Z) and the subgradient algorithm must optimize over a billion multipliers to solve the master problem of the Lagrangian dual, which is not reasonable.

Why is Amsaa much more scalable on this problem? The main difference is the way nonanticipativity constraints are handled. In Grossman's approach, these are relaxed by Lagrangian duality whereas, in Amsaa, they are enforced lazily. The lazy approach has two major advantages. First, the presence of Lagrangian multipliers alters the structure of the problem, precluding the use of a highly optimized ad-hoc solver as in Amsaa. Second, Amsaa exploits the discrete nature of the decisions, using states and transitions instead of discretizing time.

8.4. Comparison with Gap Reduction Techniques

In a very recent work, Dooms and Van Hentenryck (2007) proposed a variety of gap-reduction techniques to reduce the anticipatory gap of one-step anticipatory algorithms. The table of FIG. 10(AM) reports the relative gap (in %) between their best algorithm A_{TEPR} and Amsaa-32 s. The background color provides significance information: on Cost2 and R.6, A_{TEPR} beats Amsaa-32 s at the 5% significance level. On instances Reg, Cost5, and R1.5, the performance of the algorithms are not significantly different. On D.6, ATEPR is worse than Amsaa-31 ms. On the remaining instances, A_{TEPR} is worse than Amsaa-32 s but better than Amsaa-31 ms.

Gap-reduction techniques are an attractive alternative to Amsaa under severe time constraints. Nevertheless, Amsaa outperforms them on most instances here, sometimes with a large gap (17% on D.6), and is theoretically more appealing since it converges to the optimal decisions. Amsaa also provides the SAA upper bound, allowing to quantify the optimality gap. On the other hand, gap reduction algorithms do not provide any better bound than the expected value of the clairvoyant (h_{E}_{_{,max}}(s₀)), just like 1s-AA.

### 9. A DISCUSSION ON MODELING

There are a couple of modeling issues that deserve more discussion at this point.

About the Markov Property for the S-RCPSP When modelling the S-RCPSP as an X-MDP, there is a subtle but important modeling issue: what information to store in the states. Indeed, the uncertainty for each project is first-order Markovian: for example, conditionally on the realization of the second task, the realization of the third task is independent of realization of the first one. Therefore it is tempting not to record the first task realization in the state after the observation of the second. In at least some exemplary embodiments, this is not allowed by Amsaa. Indeed, it would violate condition (1) and raise the following problem: When the distribution ξ is approximated by a distribution with a smaller support, the Markovian structure of the uncertainty will probably not carry over to the approximated distribution. As a result, with such a state space, there would be a Markovian policy that is optimal for the original problem, but not for the problem with the approximated distribution. Therefore, converting the approximated problem into an equivalent MDP would not be possible. Note that algorithms HC-DP or B-RTDP model the problem as an MDP directly and therefore do not need to store these past observations. Hence, the state space of the MDP used by these two algorithms is smaller than the one of the X-MDP used by Amsaa. The experiments showed that the advantages of Amsaa far exceed this increase in the size of the space state.

Relationship between Exogeneity and Partial Observability It is possible to use Partially Observable Markov Decision Processes (POMDPs) to model exogeneity. Indeed, given an X-MDP, it is possible to define an equivalent POMDP, in which the hidden state space is Ξ×S and the observation space is S. The transitions are deterministic: Taking decision x in state (ξ,s) leads to the hidden state (ξ,τ(s,x,ξ) and produces the observation τ(s,x,ξ). In such a model, the concept of compatible scenarios would be replaced by the one of belief states. The nature of the X-MDP would induce several properties such as
The projection of the support of the belief state on the ξ-component is decreasing with respect to inclusion.
The projection of the support of the belief state on the s-component is always a singleton.

The link between these models shows that exogeneity is a special case of partial observability. Hence one could have modeled Stoxuno problems with POMDPs and avoided introducing the concepts of an X-MDP. However, the simplicity of X-MDPs crystallizes the essence of Amsaa, while imposing restrictions on POMDPs to make Amsaa applicable would unnecessarily clutter the presentation. Note that various ones of the exemplary embodiments of the invention may cover one or both of these approaches.

Problems with Exogenous and Endogenous Uncertainty There are problems with both exogenous and endogenous uncertainty. Consider, for instance, a hydroelectric power generation company with a large market share. Its decisions influence electricity prices, which are endogenous, but not water inflows, which are exogenous. It is possible to extend X-MDPs so as to represent the exogenous uncertainty by the scenario ξ and the endogenous uncertainty into a transition function τ:S×X×Ξ→prob(S) that returns a distribution over S. On such a model, it is still possible to use the SAA method to approximate the exogenous uncertainty, and it is still possible to convert the approximated model into an MDP. However, the resulting MDP would be harder to solve, because h_{E}_{_{,max}} would not be defined anymore.

### 10. CONCLUSION

One non-limiting contribution is Amsaa, an anytime multi-step anticipatory algorithm for online stochastic combinatorial optimization, designed to address the limitations of one-step anticipatory algorithms. Amsaa applies to stochastic optimization problems with exogenous uncertainty, whether observations are exogenous (purely exogenous problems) or endogenous (Stoxuno problems).

Amsaa assumes that problems are modeled as X-MDPs (exogenous MDPs) and iterates three fundamental steps. It first approximates the original problem, using exterior sampling, to produce a SAA problem. The resulting approximated X-MDP is then transformed into a traditional MDP which is solved (e.g., exactly) with a heuristic search algorithm. The search algorithm exploits the exogeneity of the uncertainty to obtain a good guiding heuristic based on solving offline optimization problems. Thanks to an incremental implementation of the search algorithm, the SAA problem is refined iteratively, producing increasingly finer approximations of the original problem.

Amsaa was evaluated on a stochastic resource-constrained project scheduling problem in which projects comprise a sequence of tasks with uncertain durations, costs, and success degree, which must be executed to observe their realizations. Amsaa was shown to outperform existing algorithms significantly under various time constraints, including dynamic programming in a confined space, B-RTDP, a mathematical programming approach, and the one-step anticipatory algorithm.

There are several possible research avenues to further improve Amsaa, concerned with either searching or sampling. Concerning search, the offline problems can be too expensive to solve on some problems. In that case it would be natural to use a relaxation of the offline problem. It is only at the leaves of the search tree that one may need the exact offline value. Also, it is possible that using lower bounds, as in Bounded-RTDP, could make the search more efficient. Such further aspects are included among additional exemplary embodiments of the invention.

Sampling is a difficult issue. The experiments showed that the SAA method with iid sampling has a slow convergence when the support of is finite (SAA with iid sampling is known not to converge toward the optimal decision with continuous distributions). Literature on this issue for multistage stochastic programs include some methods that may be of interest for X-MDPs, such as scenario tree generation (Dupacova et al. 2000), scenario tree refinement by importance sampling (Dempster 1998), and scenario tree reduction (Dupacova et al. 2003). Since these techniques are for purely exogenous problems, it may be difficult to adapt them to Stoxuno problems, and it is uncertain how efficient the resulting methods might be.

### 11. ADDITIONAL EXEMPLARY EMBODIMENTS

Provided below are various descriptions of additional exemplary embodiments. The exemplary embodiments of the invention described below are intended solely as non-limiting examples and should not be construed as otherwise constraining the disclosure in any way, shape or form.

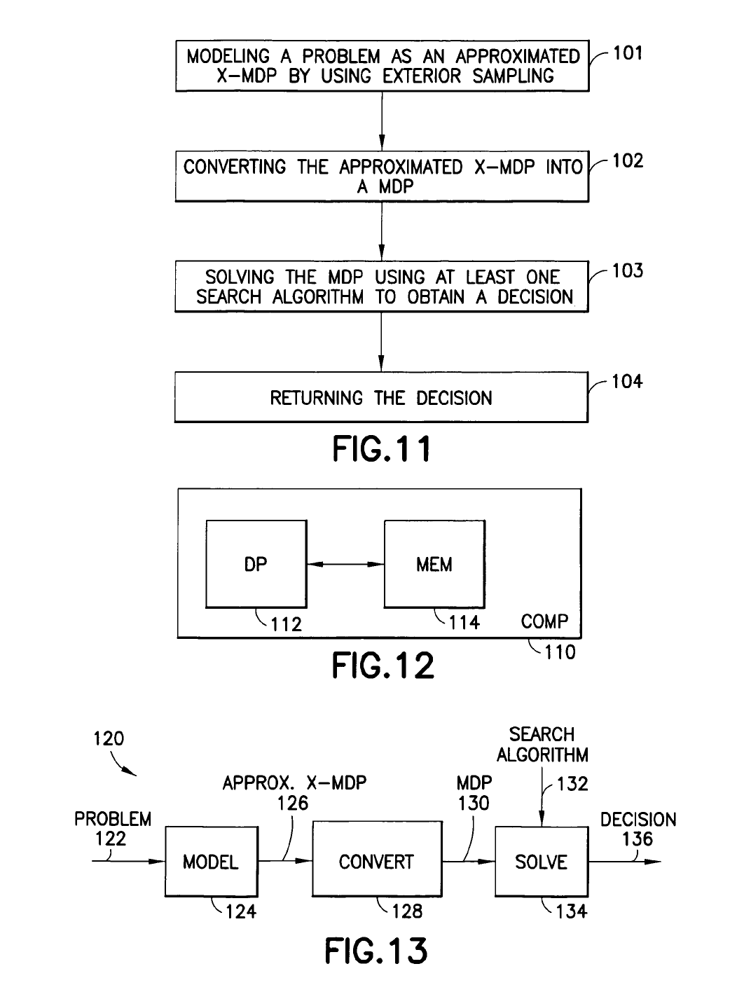

In one exemplary embodiment, and as shown in FIG. 11, a method comprising: modeling a problem as an approximated exogenous Markov decision process (X-MDP) by using exterior sampling (101); converting the approximated X-MDP into a Markov decision process (MDP) (102); solving the MDP using at least one search algorithm to obtain a decision (103); and returning the decision (104).

A method as above, wherein solving the MDP comprises using an upper bound that exploits a value of at least one offline problem associated with the approximated X-MDP. A method as in any above, wherein the method iteratively applies an algorithm (e.g., a multi-step anticipatory algorithm) on increasingly finer approximations of the X-MDP until at least one terminal condition is met. A method as in any above, wherein the at least one terminal condition comprises at least one of a time constraint or a stopping criterion based on an accuracy measurement (e.g., the contamination method). A method as in any above, wherein modeling comprises replacing a distribution of scenarios with a distribution of scenarios having a finite and comparatively/reasonably small support. A method as in any above, wherein the problem comprises an online stochastic combinatorial optimization problem or a stochastic resource-constrained project scheduling problem.

A method as in any above, wherein the decision comprises a decision selected by an optimal policy at a root node of the MDP. A method as in any above, wherein modeling comprises using the sample average approximation method. A method as in any above, wherein converting the approximated X-MDP into a MDP comprises trimming the X-MDP to remove unreachable states; and transforming the trimmed X-MDP into the MDP. A method as in any above, wherein the at least one search algorithm comprises at least one discrete optimization algorithm. A method as in any above, wherein the at least one search algorithm comprises at least one heuristic search algorithm for MDPs. A method as in any above, wherein the at least one search algorithm comprises a learning depth-first search (LDFS) algorithm. A method as in any above, wherein the method is implemented as a computer program. A method as in any above, wherein the method is implemented as a computer program stored in a computer-readable medium and executable by a processor.

In another exemplary embodiment, a computer program product comprising program instructions embodied on a tangible computer-readable medium, execution of the program instructions resulting in operations comprising the steps of any one of the above-described methods.

In another exemplary embodiment, a computer-readable medium (e.g., a memory), tangibly embodying a computer program executable by a processor for performing operations, said operations comprising the steps of any one of the above-described methods.

In another exemplary embodiment, an apparatus comprising: a memory configured to store information corresponding to (e.g., representative of) a problem; and a processor configured to model the problem as an approximated exogenous Markov decision process (X-MDP) by using exterior sampling, to convert the approximated X-MDP into a Markov decision process (MDP), to solve the MDP using at least one search algorithm, and to return a decision selected by an optimal policy at a root node of the MDP. An apparatus as in the previous, further comprising one or more additional aspects of the exemplary embodiments of the invention as further described herein.

In another exemplary embodiment, an apparatus comprising: means for modeling a problem as an approximated exogenous Markov decision process (X-MDP) by using exterior sampling; means for converting the approximated X-MDP into a Markov decision process (MDP); means for solving the MDP using at least one search algorithm; and means for returning a decision selected by an optimal policy at a root node of the MDP. An apparatus as in the previous, wherein the means for modeling, the means for converting, the means for solving and the means for returning comprises at least one of a processor, a circuit or an integrated circuit. An apparatus as in any of the previous, further comprising: means for storing information corresponding to (e.g., representative of) the problem. An apparatus as in the previous, wherein the means for storing comprises a memory. An apparatus as in any of the previous, further comprising one or more additional aspects of the exemplary embodiments of the invention as further described herein.

FIG. 12 illustrates an exemplary apparatus, such as a computer (COMP) 110, with which the exemplary embodiments of the invention may be practiced. The apparatus 110 comprises at least one data processor (DP) 112 and at least one memory (MEM) 114. As non-limiting examples, the COMP 110 may comprise a desktop computer or a portable computer. In further exemplary embodiments, the COMP 210 may further comprise one or more user interface (UI) elements, such as a display, a keyboard, a mouse or any other such UI components, as non-limiting examples.

The exemplary embodiments of this invention may be carried out by computer software implemented by the DP 112 or by hardware, or by a combination of hardware and software. As a non-limiting example, the exemplary embodiments of this invention may be implemented by one or more integrated circuits. The MEM 114 may be of any type appropriate to the technical environment and may be implemented using any appropriate data storage technology, such as optical memory devices, magnetic memory devices, semiconductor-based memory devices, fixed memory and removable memory, as non-limiting examples. The DP 112 may be of any type appropriate to the technical environment, and may encompass one or more of microprocessors, general purpose computers, special purpose computers and processors based on a multi-core architecture, as non-limiting examples.

FIG. 13 depicts a representation 120 of exemplary operations and/or components with which the exemplary embodiments of the invention may be practiced. The below-described exemplary operations may be utilized in conjunction with hardware (e.g., as described above with respect to FIG. 12), software (e.g., a computer program, such as the ones described above) or a combination of hardware and software. First a problem 122 (e.g., an online stochastic combinatorial optimization problem or a stochastic resource-constrained project scheduling problem) is modeled (MODEL) 124 as an approximated X-MDP 126 by using exterior sampling. The approximated X-MDP 126 is then converted (CONVERT) 128 into a MDP 130. The MDP 130 is solved (SOLVE) 134 using at least one search algorithm 132 to obtain a decision 136.

The exemplary blocks 124, 128, 134 shown in FIG. 13 may comprise operations, processes, one or more processing blocks, one or more functional components and/or functions performed by one or more components or blocks, as non-limiting examples. The exemplary blocks 124, 128, 134 may comprise or correspond to hardware, software or a combination of hardware and software, as non-limiting examples.

It should be noted that the above-described exemplary embodiments of the invention may further comprise one or more additional aspects, as suitable, as further described elsewhere herein.

The blocks shown in FIGS. 11-13 further may be considered to correspond to one or more functions and/or operations that are performed by one or more components, circuits, chips, apparatus, processors, computer programs and/or function blocks. Any and/or all of the above may be implemented in any practicable solution or arrangement that enables operation in accordance with the exemplary embodiments of the invention as described herein.

In addition, the arrangement of the blocks depicted in FIGS. 11-13 should be considered merely exemplary and non-limiting. It should be appreciated that the blocks shown in FIGS. 11-13 may correspond to one or more functions and/or operations that may be performed in any order (e.g., any suitable, practicable and/or feasible order) and/or concurrently (e.g., as suitable, practicable and/or feasible) so as to implement one or more of the exemplary embodiments of the invention. In addition, one or more additional functions, operations and/or steps may be utilized in conjunction with those shown in FIGS. 11-13 so as to implement one or more further exemplary embodiments of the invention.

That is, the exemplary embodiments of the invention shown in FIGS. 11-13 may be utilized, implemented or practiced in conjunction with one or more further aspects in any combination (e.g., any combination that is suitable, practicable and/or feasible) and are not limited only to the steps, blocks, operations and/or functions shown in FIGS. 11-13.

Still further, the various names used for the different parameters, variables, components and/or items are not intended to be limiting in any respect, as these parameters, variables, components and/or items may be identified by any suitable names.

Any use of the terms “connected,” “coupled” or variants thereof should be interpreted to indicate any such connection or coupling, direct or indirect, between the identified elements. As a non-limiting example, one or more intermediate elements may be present between the “coupled” elements. The connection or coupling between the identified elements may be, as non-limiting examples, physical, electrical, magnetic, logical or any suitable combination thereof in accordance with the described exemplary embodiments.

As non-limiting examples, the connection or coupling may comprise one or more printed electrical connections, wires, cables, mediums or any suitable combination thereof.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications will still fall within the scope of the teachings of the exemplary embodiments of the invention.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
modeling, by at least one processor, a problem as an approximated exogenous Markov decision process (X-MDP);
converting, by the at least one processor, the approximated X-MDP into a Markov decision process (MDP);
solving, by the at least one processor, the MDP using at least one search algorithm to obtain a decision; and
returning, by the at least one processor, the decision.

2. The method as in claim 1, where the problem comprises an online stochastic combinatorial optimization problem.

3. The method as in claim 1, where modeling comprises replacing a distribution of scenarios for the problem by a replacement distribution having a finite and comparatively small support.

4. The method as in claim 1, where modeling comprises using exterior sampling.

5. The method as in claim 1, where modeling comprises using a sample average approximation (SAA) method.

6. The method as in claim 1, where converting comprises: trimming the approximated X-MDP to remove unreachable states and to mark as final states in which all uncertainty has been revealed; and transforming the trimmed X-MDP into the MDP.

7. The method as in claim 1, where solving comprises using an upper bound that exploits a value of offline problems associated with the approximated X-MDP.

8. The method as in claim 1, where the decision is selected by an optimal policy at a root node of the MDP.

9. The method as in claim 1, where the steps of modeling, converting, solving and returning are iterated.

10. The method as in claim 9, where the iteration is performed on increasingly finer approximations of the approximated X-MDP until a termination condition is met.

11. The method as in claim 10, where the termination condition comprises a time constraint, a stopping criterion or a stopping criterion based on an accuracy measurement.

12. The method as in claim 9, where the iteration stems from an upper bound for the subsequent approximating step that is derived from an optimal policy value derived from the previous approximation.

13. The method as in claim 9, where the iteration reuses internal data structures.

14. The method as in claim 1, where the method is implemented by a computer program stored on a computer-readable medium.

15. An apparatus comprising:
a memory configured to store input data descriptive of a problem; and
at least one processor configured to receive the input data from the memory, to model the problem as an approximated exogenous Markov decision process (X-MDP), to convert the approximated X-MDP into a Markov decision process (MDP), to solve the MDP using at least one search algorithm to obtain a decision, and to return the decision.

16. The apparatus as in claim 15, where modeling by the at least one processor comprises using exterior sampling.

17. The apparatus as in claim 15, where the steps of modeling, converting, solving and returning by the at least one processor are iterated.

18. A program storage device readable by a machine, tangibly embodying a program of instructions executable by the machine for performing operations, said operations comprising:
modeling a problem as an approximated exogenous Markov decision process (X-MDP);
converting the approximated X-MDP into a Markov decision process (MDP);
solving the MDP using at least one search algorithm to obtain a decision; and
returning the decision.

19. The program storage device as in claim 18, where modeling comprises using exterior sampling.

20. The program storage device as in claim 18, where the steps of modeling, converting, solving and returning are iterated.
